(19) United States
(12) Patent Application Publication
(10) Pub. No.: US 2013/0091415 A1
(43) Pub. Date: Apr. 11, 2013

(54) SYSTEMS AND METHODS FOR INVISIBLE AREA DETECTION AND CONTEXTUALIZATION

(71) Applicants: Roy Stilling, Tarrytown, NY (US); Alistair Russell, London (GB)

(72) Inventors: Roy Stilling, Tarrytown, NY (US); Alistair Russell, London (GB)

(21) Appl. No.: 13/436,189

(22) Filed: Mar. 30, 2012

Related U.S. Application Data
(60) Provisional application No. 61/470,768, filed on Apr. 1, 2011.

(51) Int. Cl. G06F 17/21

(52) U.S. Cl. CPC G06F 17/211
USPC 715/234

(57) ABSTRACT

Where a page has dynamic (DHTML) content that isn't visible to the end-user when the page is first rendered, a client agent of the augmentation system of the present solution detects the visibility status of areas that may become visible after end-user action. The client agent adds event handlers so that upon these areas becoming visible the client agent sends the content data of the invisible areas, now visible, to the server and receive a new set of hooks and adverts to place in the newly visible content.

### RELATED APPLICATION

This application claims the benefit of and priority to U.S. Provisional Application No. 61/470,768, entitled “Systems and Methods For Invisible Area Detection and Contextualization” and filed on Apr. 1, 2011, which is incorporated herein by reference in its entirety for all purposes.

### FIELD OF THE INVENTION

The disclosure generally relates to the field of data augmentation, in particular to augmenting textual content in documents based on fetching content from uniform resource locators not being displayed in the document.

### BACKGROUND

Hypertext is used to provide information in a web page. Hypertext is the organization of computer based text into connected associations enabling a user to quickly access information that the user chooses. An instance of such an association is called a hyperlink or hypertext link. A hyperlink, when selected, leads the viewer to another web page (or file or resource, collectively called the destination page).

In order to access the supplemental information provided through hyperlinks, viewers are required to leave their current web pages. This requirement interrupts the viewers' web browsing experience. As a result, most viewers are reluctant to visit the destination page provided by hyperlinks.

In addition, traditionally the hyperlinks are generated by human editors, a process that is both tedious and subject to human errors. Further, by the time a viewer tries to visit a destination page of a hyperlink, the destination page may cease to exist or have evolved to no longer provide the related information.

In some cases, the viewer leaves the web page to visit a destination page that does not have information desired by the viewer. The user then may have to search for other destination pages to try to obtain the desired information. This may lead the viewer to perform multiple searches and visit several pages to find the desired information. The viewer may become frustrated with the amount of activity to find or not find the desired information and with leaving the current destination page to do so.

### SUMMARY OF THE INVENTION

On some web sites some of the content present on the page is not visible to the end user when the page first renders. To access this content, the end-user has to click on a link on the page. When they do so, the content they have been reading is replaced by new content. All the content is present in the page and is hidden and revealed using JavaScript/DHTML techniques. When an augmentation system harvests the content, the augmentation system may know whether the content is visible or not to the end user. The hooking placement policy results in hooks being mostly placed on the first, visible, “page” of content, fewer on the subsequent “page” and probably none at all on the end “pages” This results in missed opportunities to place hooks and adverts and gain revenue.

Where a page has dynamic (DHTML) content that isn't visible to the end-user when the page is first rendered, a client agent of the augmentation system of the present solution detects the visibility status of areas that may become visible after end-user action. The client agent adds event handlers so that upon these areas becoming visible the client agent sends the content data of the invisible areas, now visible, to the server and receive a new set of hooks and adverts to place in the newly visible content.

In some aspects, the present solution is directed to a method for detecting changes to content of dynamic page content of a web page. The method includes detecting, by an agent, executing on a client, while a browser is displaying a web page comprising dynamic page content that programmatically switches page content responsive to a user selection via a page selector, whether each of the areas that may be displayed within the dynamic page content is visible or not visible. The agent includes, while the browser is displaying the web page, for each of the areas of the dynamic page content detected to be invisible, an event handler in the dynamic page content to be triggered upon each area becoming visible. The method also includes generating, by the agent responsive to triggering of the event handler for an area, a uniform resource locator (URL) for the area switched to be visible in the dynamic page content; and transmitting, by the agent to a server, page data identified by the URL. The page data comprises text identified from the page content of the visible area of the dynamic page content.

In some embodiments, the method includes determining, by the server, keywords from the text of the page data for the visible area. In some embodiments, the method includes determining, by the server, a campaign for the keywords. In some embodiments, the method includes communicating or transmitting, by the server to the client, the campaign for the URL. In some embodiments, the method includes comparing, by the agent, nodes of the web page to a predetermined list of nodes. In some embodiments, the method includes checking, by the agent, a visibility property corresponding to a node matching the predetermined list of nodes. In some embodiments, the method includes attaching, by the agent, the event handler to nodes corresponding to areas detected as invisible. In some embodiments, the method includes generating, by the agent, a URL comprising a URL unique to the visible area. In some embodiments, the method includes generating, by the agent, a URL based on an identifier of a node corresponding to the visible area. In some embodiments, the method includes harvesting, by the agent, content from the visible area to generate the page data.

In some aspects, the present solution is directed to a system for detecting changes to content of dynamic page content of a web page. The system includes agent, executing on a client comprising a browser displaying a web page. The web page includes dynamic page content that programmatically switches page content responsive to a user selection via a page selector. The system includes a visibility detector of the agent that detects, while the browser is displaying the web page, whether each of the areas that may be displayed within the dynamic page content is visible or not visible. The agent includes an event handler in the dynamic page content for each of the areas of the dynamic page content detected to be invisible. The event handler to be triggered upon each area becoming visible. The system also includes a pseudo-URL generator of the agent. Responsive to triggering of the event handler for an area, the pseudo-URL generator generates a uniform resource locator (URL) for the area switched to be visible in the dynamic page content. The agent transmits to a server page data identified by the URL. The page data having text identified from the page content of the visible area of the dynamic page content.

In some embodiments, the server determines keywords from the text of the page data for the visible area. The server may determine a campaign for the keywords and communicate to the client the campaign for the URL. In some embodiments, the visibility detector compares nodes of the web page to a predetermined list of nodes and checks a visibility property corresponding to a node matching the predetermined list of nodes. The agent may attach the event handler to nodes corresponding to areas detected as invisible. In some embodiments, the pseudo-URL generator generates a URL comprising a URL unique to the visible area. In some embodiments, the pseudo-URL generator generates a URL based on an identifier of a node corresponding to the visible area. Te agent may harvests content from the visible area to generate the page data that is sent to the server for augmentation or campaign selection.

### BRIEF DESCRIPTION OF DRAWINGS

The foregoing and other objects, aspects, features, and advantages of the present invention will become more apparent and better understood by referring to the following description taken in conjunction with the accompanying drawings, in which:

FIG. 1A is a block diagram that depicts an embodiment of an environment for providing systems and methods described herein.

FIGS. 1B and 1C are block diagrams of computing devices that may be used in any of the embodiments of the systems and methods described herein

FIG. 2 is a block diagram that depicts an embodiment of an augmentation server in FIG. 1.

FIG. 3A is a flow diagram of an embodiment of a method of producing augmented content.

FIG. 3B is a flow diagram of an embodiment of a method of providing augmented content to users.

FIG. 3C is a flow diagram of an embodiment of a process of operation of advertisement and client code.

FIGS. 4A through 4E are screenshots illustrating a web page, its corresponding augmented web page, and a viewer's user experience interacting with the augmented web page according to one embodiment of the present disclosure.

FIG. 5A is block diagram of an embodiment of an ad server platform and platform services.

FIG. 5B is a diagram of an embodiment of stages of a request from a client for platform services.

FIG. 5C is a diagram of an embodiment of contextual targeting.

FIG. 5D is a diagram of another embodiment of contextual targeting.

FIG. 5E is a diagram of an embodiment of contextual and behavioral targeting.

FIG. 5F is a diagram of another embodiment of contextual and behavioral targeting.

FIG. 5G is a diagram of another embodiment of contextual and behavioral targeting.

FIG. 5H is a diagram of an embodiment of campaign selection engine.

FIG. 5I is block diagram of an embodiment of a system to provide augmented content for a keyword on a web page.

FIG. 5J is a diagrammatic view of an embodiment of augmented content.

FIG. 5K is a flow diagram of an embodiment of a method for delivering augmented content for a keyword on a web page.

FIG. 6A is a block diagram of an embodiment of a system for content harvesting keywords.

FIG. 6B is a flow diagram of an embodiment of a method for delivering augmented content for keywords identified via content harvesting.

FIG. 6C is a flow diagram of another embodiment of a method for delivering augmented content for keywords identified via content harvesting.

FIG. 7A is a block diagram of an embodiment of a pages having visible and invisible areas.

FIG. 7B is a block diagram of an embodiment of a system for invisible area detection and contextualization.

FIG. 7C is a flow diagram of an embodiment of a method for invisible area detection and contextualization.

In the drawings, like reference numbers generally indicate identical, functionally similar, and/or structurally similar elements.

### DETAILED DESCRIPTION

For purposes of reading the description of the various embodiments below, the following descriptions of the sections of the specification and their respective contents may be helpful:
Section A describes a network and computing environment which may be useful for practicing embodiments described herein;
Section B describes embodiments of systems and methods for delivering a augmented content;
Section C describes embodiments of systems and methods of an ad server platform for delivering a plurality of advertisement and augmented content services;
Section D describes embodiments of systems and methods of content harvesting to identify keywords and delivery augmented content; and
Section E describes embodiments of systems and methods for invisible area detection and contextualization.

A. System and Network Environment

Some of the disclosed embodiments describe examples of a method (and corresponding system and computer program product) for augmenting files with related resources through layered augmentation. Viewers of the augmented files can access the related resources through a multi-layered dialog box. The process of providing additional resources through multilayered dialog box and the multi-layered dialog box are collectively called layered augmentation.

An embodiment of the method identifies data in a file, associates the identified data with reference data in a reference database, and stores the associations in a corresponding augmented file. A viewer of the augmented file can access resources related to a piece of augmented data through layered augmentation. When the viewer moves a pointer over the piece of augmented data (also called mouse-over), the related resources are provided in a multi-layered dialog box. The dialog box is overlaid on the augmented file approximate to the position where the mouse-over occurred. The viewer can navigate through the related resources in the dialog box without leaving the augmented file.

As described herein, a file includes any types of documents such as web pages. Augmented data, the data with integrated association in an augmented file, include any types of content such as text and image. Resources provided through layered augmentations include textual content, visual content such as images and videos, interactive controls such as dialog boxes, and services such as Internet search service and advertisement. A pointer can be any pointer device such as a mouse, a trackball, a roller, and a touchpad. For purposes of illustration, the method (and corresponding system and computer program product) is described in terms of augmenting keywords (or key phrases) in web pages and delivering related advertisements through multi-layered dialog boxes based on user interactions with the augmented keywords, even though the disclosed embodiments apply to all other types of content, files, and resources as defined above.

The figures and the following description relate to embodiments by way of illustration only. Reference will now be made in detail to several embodiments, examples of which are illustrated in the accompanying figures. The figures depict embodiments of the disclosed system (or method) for purposes of illustration only. It should be noted that from the following discussion, other or alternate embodiments of the structures and methods disclosed herein will be readily recognized by one skilled in the art as viable alternatives that may be employed without departing from the principles described herein.

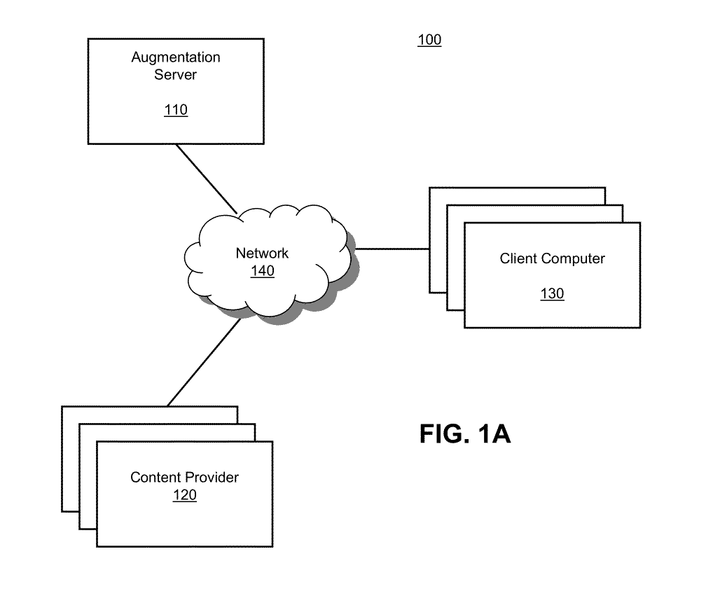

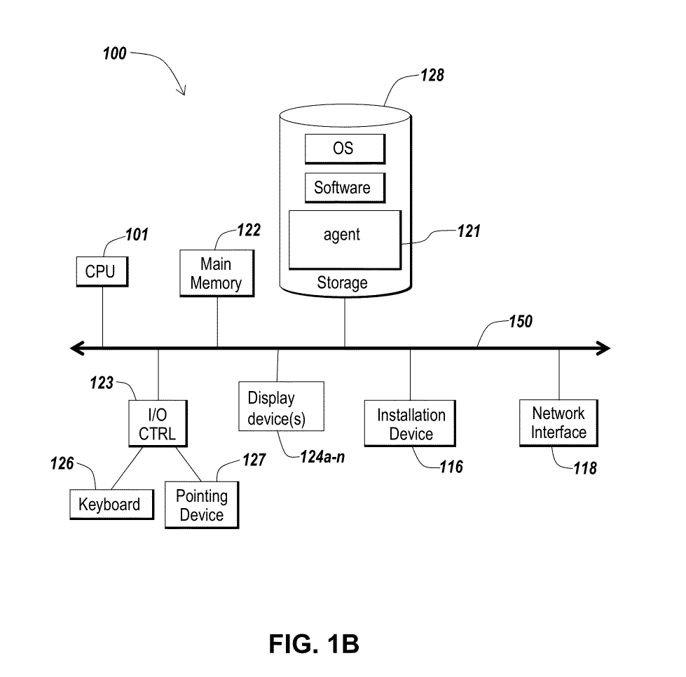

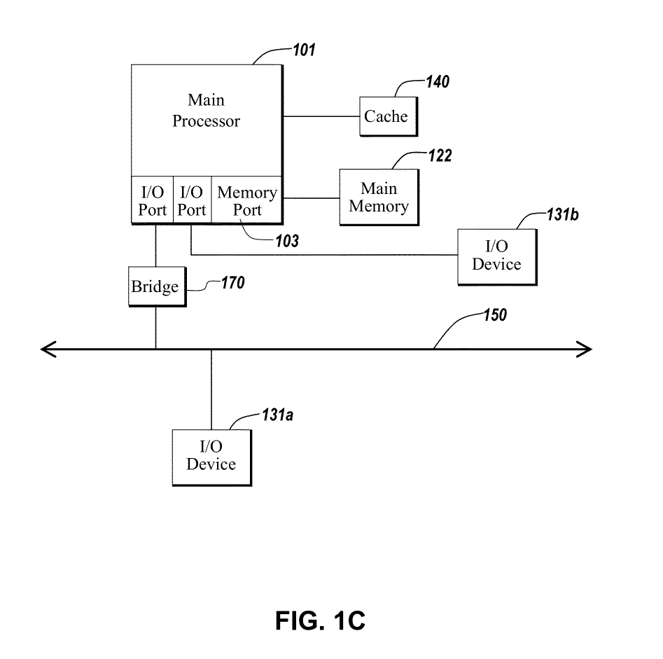

FIG. 1A illustrates an embodiment of a computing environment 100 for augmenting web pages and providing viewers of the augmented web pages with related advertisements through layered augmentation based on user interaction. As illustrated, the computing environment 100 includes an augmentation server 110, multiple content providers (or websites) 120, and one or more client computers (or user systems) 130, all of which are communicatively coupled through a network 140.

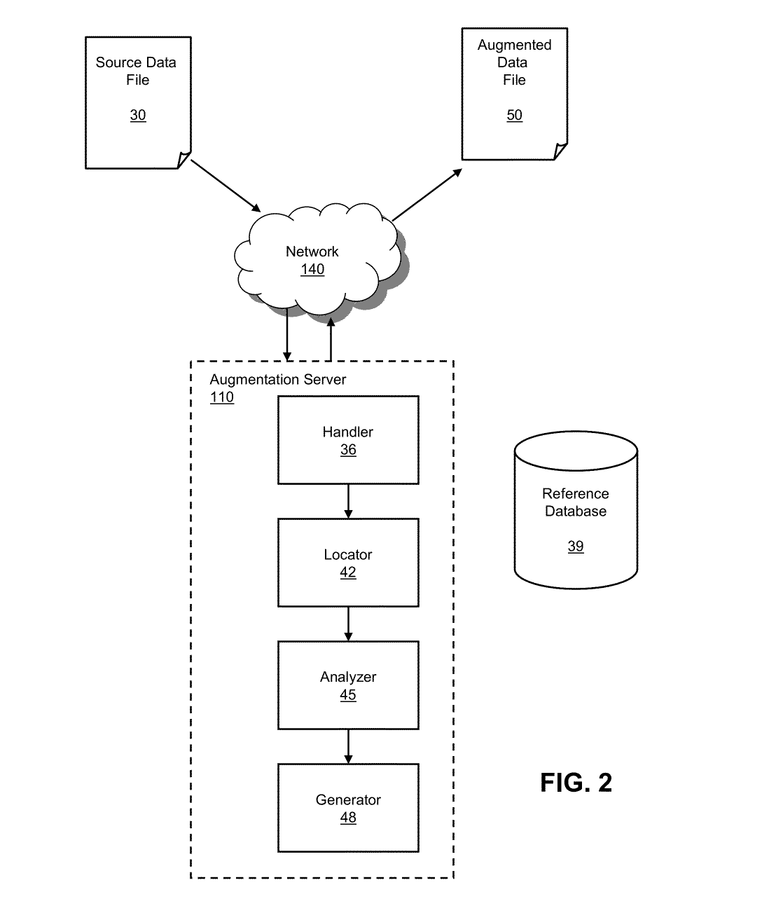

The augmentation server 110 is configured to augment keywords (or other types of content) in web pages (or other types of documents) with advertisements (or other types of resources), and deliver the advertisements based on user interaction with the augmented keywords. The augmentation server 110 retrieves web pages from the content providers 120 and augments the web pages. The augmentation server 110 augments a web page by identifying keywords in the web page, associating (or tagging) the keywords with one or more related references in a reference database, generating an augmented web page, and storing the associations in a database. When a user views an augmented web page in a client computer 130 and moves a pointer over one of the augmented keywords (hereinafter “the activated keyword”), the augmentation server 110 displays (or avails) related advertisements in the client computer 130 through a multi-layered dialog box. An example architecture of the augmentation server 110 is described in detail below with respect to FIG. 2.

The content providers 120 are entities that provide (or generate), host, publish, control, or otherwise have rights over a collection of web pages (or other types of documents). In one embodiment, the content providers 120 are web servers hosting web pages for viewers to access. The content providers 120 may provide web pages to the augmentation server 110 for layered augmentation. Alternatively, the content providers 120 may either instruct or give permission to the augmentation server 110 to retrieve all or parts of their web pages for layered augmentation.

A client 130 may comprise any personal computer (e.g., based on a microprocessor from the x86 family, the Pentium family, the 680×0 family, PowerPC, PA-RISC, MIPS families, the ARM family, the Cell family), network computer, wireless device (e.g. mobile computer, PDA, smartphone), information appliance, workstation, minicomputer, mainframe computer, telecommunications or media device that is capable of communication and that has sufficient processor power and memory capacity to perform the operations described herein. For example, the client 130 may comprise a device of the IPOD family of devices manufactured by Apple Computer of Cupertino, Calif., a PLAYSTATION 2, PLAYSTATION 3, or PERSONAL PLAYSTATION PORTABLE (PSP) device manufactured by the Sony Corporation of Tokyo, Japan, a NINTENDO DS, NINTENDO GAMEBOY, NINTENDO GAMEBOY ADVANCED, NINTENDO REVOLUTION, or NINTENDO WII device manufactured by Nintendo Co., Ltd., of Kyoto, Japan, or an XBOX or XBOX 360 device manufactured by the Microsoft Corporation of Redmond, Wash. In some embodiments, the client may include any of the Kindle family of devices sold or provided by Amazon.com.

Operating systems supported by the client 130 can include any member of the WINDOWS family of operating systems from Microsoft Corporation of Redmond, Wash., MacOS, JavaOS, various varieties of Unix (e.g., Solaris, SunOS, Linux, HP-UX, A/IX, and BSD-based distributions), any embedded operating system, any real-time operating system, any open source operating system, any proprietary operating system, any operating systems for mobile computing devices, or any other operating system capable of running on the computing device and performing the operations described herein. Typical operating systems include: WINDOWS 3.x, WINDOWS 95, WINDOWS 98, WINDOWS 2000, WINDOWS NT 3.51, WINDOWS NT 4.0, WINDOWS CE, WINDOWS XP, and WINDOWS VISTA, all of which are manufactured by Microsoft Corporation of Redmond, Wash.; Mac OSX, manufactured by Apple Computer of Cupertino, California; OS/2, manufactured by International Business Machines of Armonk, N.Y.; and Linux, an open source operating system distributed by, among others, Red Hat, Inc., or any type and/or form of a Unix operating system, among others.

The client computers 130 may be any type and form of client devices for users to browse web pages (or other types of documents). In one embodiment, a client computer 130 includes a pointer device (e.g., a mouse, a trackball, a roller, a touchpad, or the like), a conventional web browser (e.g., Microsoft Internet Explorer™, Mozilla Firefox™, or Apple Safari™), and can retrieve and display web pages from the content providers 120 in a conventional manner (e.g., using the HyperText Transfer Protocol). In one embodiment, the client computer 130 displays augmented keywords in an augmented web page differently than the non-augmented content. For example, the augmented keywords can be displayed in a double underline style and/or in a color distinctive from texts that are not augmented. When a user moves a pointer (e.g., mouse pointer) over (e.g., mouse-over) an augmented keyword in the augmented web page, the client computer 130 (or the utilized web browser) generates a request and transmits the request to the augmentation server 110. The augmentation server 110 receives the request and determines relevant advertisements to transmit to the client computer 130. The client computer 130 (or the utilized web browser) displays the advertisements retrieved from the augmentation server 110 in a multi-layered dialog box overlaying the augmented web page and proximate to the location where the mouse-over occurred. The multi-layered dialog box displays an advertisement and multiple clickable tabs representing the other retrieved advertisements. The viewer can select (e.g., click) a tab to request the dialog box to display the corresponding advertisement. The viewer may navigate among the multiple advertisements and interact with the advertisements without leaving the augmented web page.

The network 140 is configured to communicatively connect the augmentation server 110, the content providers 120, and the client computers 130. The network 140 may be a wired or wireless network. Examples of the network 140 include the Internet, an intranet, a WiFi network, a WiMAX network, a mobile telephone network, or a combination thereof. The network 140 may be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. In some embodiments, the network 140 may comprise a wireless link, such as an infrared channel or satellite band. The topology of the network 140 may be a bus, star, or ring network topology. The network 140 and network topology may be of any such network or network topology as known to those ordinarily skilled in the art capable of supporting the operations described herein. The network may comprise mobile telephone networks utilizing any protocol or protocols used to communicate among mobile devices, including AMPS, TDMA, CDMA, GSM, GPRS or UMTS. In some embodiments, different types of data may be transmitted via different protocols. In other embodiments, the same types of data may be transmitted via different protocols.

In one embodiment, the augmentation server 110, the content providers 120, and/or the client computers 130 are structured to include a processor, memory, storage, network interfaces, and applicable operating system and other functional software (e.g., network drivers, communication protocols). The client 120, server 110, and content providers 120 may be deployed as and/or executed on any type and form of computing device, such as a computer, network device or appliance capable of communicating on any type and form of network and performing the operations described herein.

FIGS. 1B and 1C depict block diagrams of a computing device 100 useful for practicing an embodiment of the client 130, server 110 or content provider 120. As shown in FIGS. 1B and 1C, each computing device 100 includes a central processing unit 101, and a main memory unit 122. As shown in FIG. 1B, a computing device 100 may include a visual display device 124, a keyboard 126 and/or a pointing device 127, such as a mouse. Each computing device 100 may also include additional optional elements, such as one or more input/output devices 131a-131b (generally referred to using reference numeral 131), and a cache memory 140 in communication with the central processing unit 101.

The central processing unit 101 is any logic circuitry that responds to and processes instructions fetched from the main memory unit 122. In many embodiments, the central processing unit is provided by a microprocessor unit, such as: those manufactured by Intel Corporation of Mountain View, Calif.; those manufactured by Motorola Corporation of Schaumburg, Ill.; those manufactured by Transmeta Corporation of Santa Clara, Calif.; the RS/6000 processor, those manufactured by International Business Machines of White Plains, N.Y.; or those manufactured by Advanced Micro Devices of Sunnyvale, Calif. The computing device 100 may be based on any of these processors, or any other processor capable of operating as described herein.

Main memory unit 122 may be one or more memory chips capable of storing data and allowing any storage location to be directly accessed by the microprocessor 101, such as Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC100 SDRAM, Double Data Rate SDRAM (DDR SDRAM), Enhanced SDRAM (ESDRAM), SyncLink DRAM (SLDRAM), Direct Rambus DRAM (DRDRAM), or Ferroelectric RAM (FRAM). The main memory 122 may be based on any of the above described memory chips, or any other available memory chips capable of operating as described herein. In the embodiment shown in FIG. 1B, the processor 101 communicates with main memory 122 via a system bus 150 (described in more detail below). FIG. 1C depicts an embodiment of a computing device 100 in which the processor communicates directly with main memory 122 via a memory port 103. For example, in FIG. 1B the main memory 122 may be DRAM.

FIG. 1C depicts an embodiment in which the main processor 101 communicates directly with cache memory 140 via a secondary bus, sometimes referred to as a backside bus. In other embodiments, the main processor 101 communicates with cache memory 140 using the system bus 150. Cache memory 140 typically has a faster response time than main memory 122 and is typically provided by SRAM, BSRAM, or EDRAM. In the embodiment shown in FIG. 1C, the processor 101 communicates with various I/O devices 131 via a local system bus 150. Various busses may be used to connect the central processing unit 101 to any of the I/O devices 131, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 124, the processor 101 may use an Advanced Graphics Port (AGP) to communicate with the display 124. FIG. 1C depicts an embodiment of a computer 100 in which the main processor 101 communicates directly with I/O device 131b via HyperTransport, Rapid I/O, or InfiniBand. FIG. 1C also depicts an embodiment in which local busses and direct communication are mixed: the processor 101 communicates with I/O device 131b using a local interconnect bus while communicating with I/O device 131a directly.

The computing device 100 may support any suitable installation device 116, such as a floppy disk drive for receiving floppy disks such as 3.5-inch, 5.25-inch disks or ZIP disks, a CD-ROM drive, a CD-R/RW drive, a DVD-ROM drive, tape drives of various formats, USB device, hard-drive or any other device suitable for installing software and programs such as any software 121 related to providing an agent, such as a safe agent, as described herein. The computing device 100 may further comprise a storage device 128, such as one or more hard disk drives or redundant arrays of independent disks, for storing an operating system and other related software, and for storing application software programs such as any program related to an agent 121 as described herein. Optionally, any of the installation devices 116 could also be used as the storage device 128. Additionally, the operating system and the software can be run from a bootable medium, for example, a bootable CD, such as KNOPPIX®, a bootable CD for GNU/Linux that is available as a GNU/Linux distribution from knoppix.net.

Furthermore, the computing device 100 may include a network interface 118 to interface to a Local Area Network (LAN), Wide Area Network (WAN) or the Internet through a variety of connections including, but not limited to, standard telephone lines, LAN or WAN links (e.g., 802.11, T1, T3, 56 kb, X.25), broadband connections (e.g., ISDN, Frame Relay, ATM), wireless connections, or some combination of any or all of the above. The network interface 118 may comprise a built-in network adapter, network interface card, PCMCIA network card, card bus network adapter, wireless network adapter, USB network adapter, modem or any other device suitable for interfacing the computing device 100 to any type of network capable of communication and performing the operations described herein.

A wide variety of I/O devices 131a-131n may be present in the computing device 100. Input devices include keyboards, mice, trackpads, trackballs, microphones, and drawing tablets. Output devices include video displays, speakers, inkjet printers, laser printers, and dye-sublimation printers. The I/O devices 131 may be controlled by an I/O controller 123 as shown in FIG. 1B. The I/O controller may control one or more I/O devices such as a keyboard 126 and a pointing device 127, e.g., a mouse or optical pen. Furthermore, an I/O device may also provide storage 128 and/or an installation medium 116 for the computing device 100. In still other embodiments, the computing device 100 may provide USB connections to receive handheld USB storage devices such as the USB Flash Drive line of devices manufactured by Twintech Industry, Inc. of Los Alamitos, California.

In some embodiments, the computing device 100 may comprise or be connected to multiple display devices 124a-124n, which each may be of the same or different type and/or form. As such, any of the I/O devices 131a-131n and/or the I/O controller 123 may comprise any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may comprise multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices, such as computing devices 100a and 100b connected to the computing device 100, for example, via a network. These embodiments may include any type of software designed and constructed to use another computer's display device as a second display device 124a for the computing device 100. One ordinarily skilled in the art will recognize and appreciate the various ways and embodiments that a computing device 100 may be configured to have multiple display devices 124a-124n.

In further embodiments, an I/O device 131 may be a bridge 170 between the system bus 150 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCl/LAMP bus, a FibreChannel bus, or a Serial Attached small computer system interface bus.

A computing device 100 of the sort depicted in FIGS. 1B and 1C typically operate under the control of operating systems, which control scheduling of tasks and access to system resources. The computing device 100 can be running any operating system such as any of the versions of the Microsoft® Windows operating systems, the different releases of the Unix and Linux operating systems, any version of the Mac OS® for Macintosh computers, any embedded operating system, any real-time operating system, any open source operating system, any proprietary operating system, any operating systems for mobile computing devices, or any other operating system capable of running on the computing device and performing the operations described herein. Typical operating systems include: WINDOWS 3.x, WINDOWS 95, WINDOWS 98, WINDOWS 2000, WINDOWS NT 3.51, WINDOWS NT 4.0, WINDOWS CE, and WINDOWS XP, all of which are manufactured by Microsoft Corporation of Redmond, Wash.; MacOS, manufactured by Apple Computer of Cupertino, California; OS/2, manufactured by International Business Machines of Armonk, N.Y.; and Linux, a freely-available operating system distributed by Caldera Corp. of Salt Lake City, Utah, or any type and/or form of a Unix operating system, among others.

In other embodiments, the computing device 100 may have different processors, operating systems, and input devices consistent with the device. For example, in one embodiment the computer 100 is a Treo 180, 270, 1060, 600 or 650 smart phone manufactured by Palm, Inc. In this embodiment, the Treo smart phone is operated under the control of the PalmOS operating system and includes a stylus input device as well as a five-way navigator device. In some embodiments, the computing device may include any type and form of wireless reading device, such as any Kindle device manufactured by Amazon.com Inc. of Seattle, Wash. Moreover, the computing device 100 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

B. Systems and Methods for Providing Augmented Content

FIG. 2 is a block diagram illustrating one example architecture of the augmentation server 110 as described above with respect to FIG. 1. As illustrated, the augmentation server 110 includes a handler 36, a locator 42, an analyzer 45, a generator 48, and a reference database 39. The components 36 through 45 may include a software or firmware instruction that can be stored within a tangible computer readable medium (e.g., magnetic disk drive, optical disk or solid state memory such as flash memory, or random-access memory) and executed by a processor or equivalent electrical circuits, state machines, microcode, or the like.

A source data file 30 (e.g., a web page) resides on a server (e.g., a content provider 120) on a network 140 (e.g., the Internet). The handler 36 retrieves the source data file 30 for augmentation by the augmentation server 110. The locator 42 examines the retrieved source data file 30 for comparison to data in the reference database 39. In one embodiment, the locator 42 analyzes content of the source data file 30 for keywords, searches corresponding reference data in the reference database 39, and provides the keywords and the corresponding reference data to the analyzer 45. In an alternate embodiment, rather than analyzing the source data file 30 for keywords, the locator 42 retrieves a list of keywords from the reference database 39 and enumerates through the textual content of the source data file 30 for matches.

The analyzer 45 creates associations between the keywords and the corresponding reference data found by the locator 42. The generator 48 generates an augmented data file 50 by embedding the associations created by the analyzer 45 in the source data file 30. The generator 48 embeds associations by generating intelligent tags for the keywords, and augmenting the keywords with the intelligent tags. In one embodiment, an intelligent tag is an alphabetic and/or numeric string that identifies its associated keywords, and/or reference data, and optionally includes an unique identification number (hereinafter called the association ID). The generator 48 inserts the generated intelligent tags into the source data file 30 to generate the augmented data file 50. Web pages with the integrated intelligent tags are called augmented web pages. Keywords with the integrated intelligent tags are called augmented keywords. The generator 48 also stores the identified keywords and/or the associations in a database for later references.

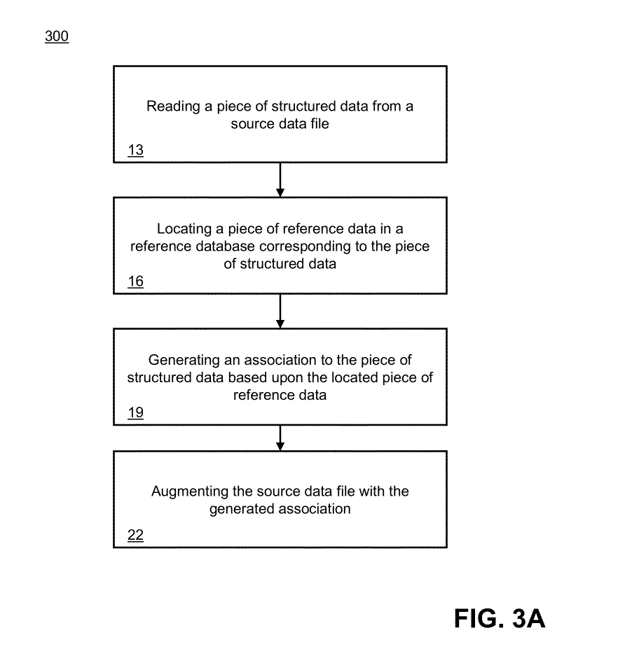

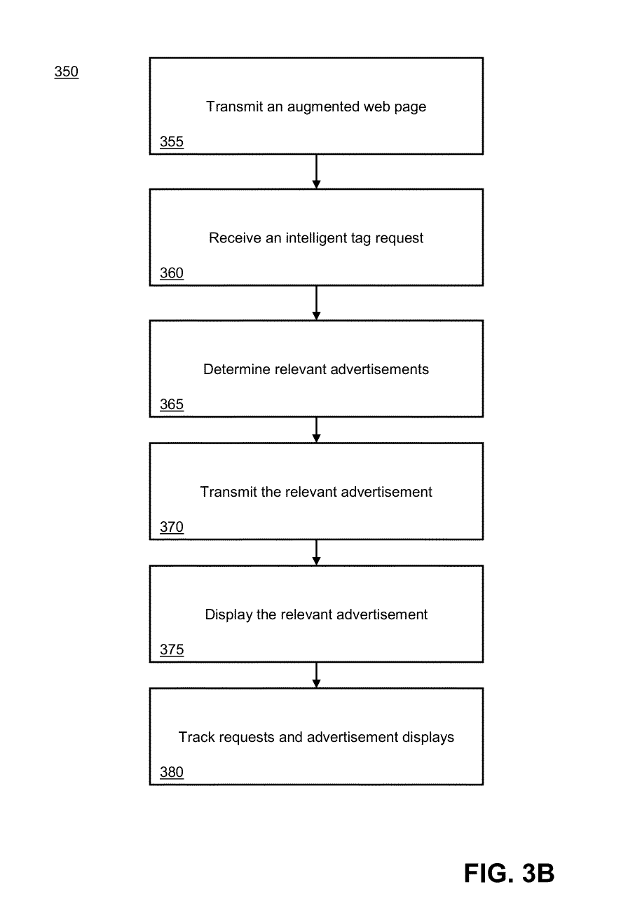

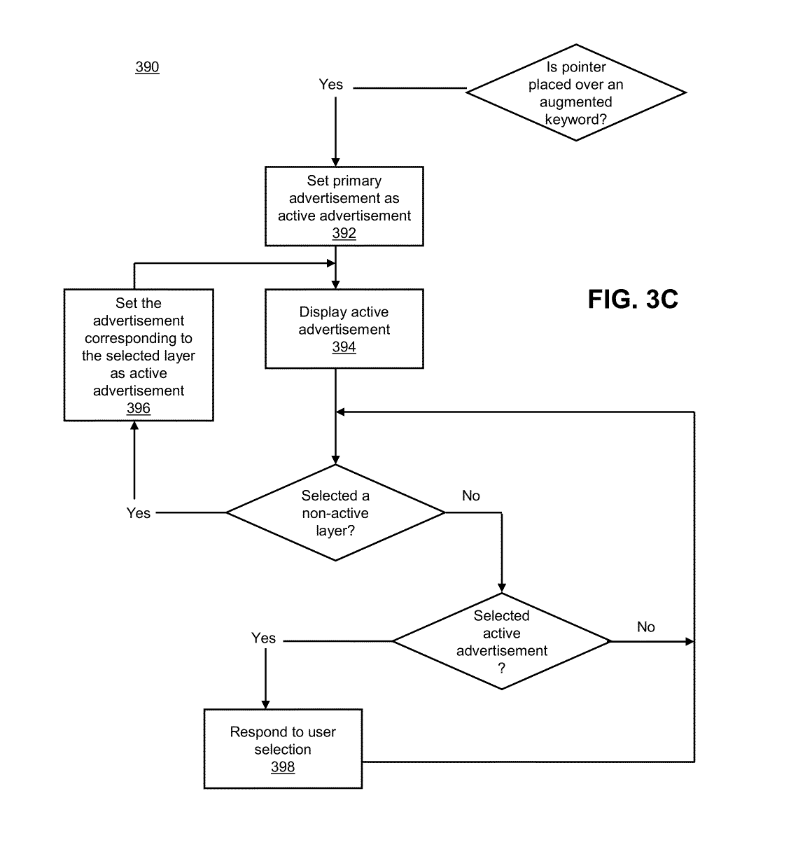

The resulting augmented data file 50 is returned to the handler 36 to reside at a Universal Resource Locator (URL) address on the network 140 (e.g., at the content provider 120 from which the source data file 30 is retrieved). In one embodiment, the handler 36 also receives requests (or signals) from client computers 130 indicating user interactions with the augmented data file, and transmits to the client computers 130 related advertisements for display through layered augmentation. Layered augmentation is described in detail below with respect to FIGS. 3A through 3C. The handler 36 retrieves the activated keywords (e.g., from the requests), and determines one or more relevant advertisements from an advertising database (not shown) that matches the keywords and/or the associated reference data. In one embodiment, rather than transmitting the related advertisements, the handler 36 transmits addresses (e.g., URLs) of the relevant advertisements to the requesting client computer 130. The client computer 130 resolves the addresses to retrieve the advertisements.

The reference database 39 stores reference data such as types of advertisements (e.g., television advertisements), categories of advertisements (e.g., storage rental, home equity loan), and/or information about specific advertisements (e.g., associated keywords, format information, price the advertiser is willing to pay, and URL of the advertisement). The reference database 39 may be a relational database or any other type of database that stores the data, such as a flat file. In one embodiment, the reference database 39 is a web enabled reference database supporting remote calls through the Internet to the reference database 39.

The components of the augmentation server 110 can reside on a single computer system or several computer systems located close by or remotely from each other. For example, the analyzer 45 and the generator 48 may reside on separate web servers, and the reference database 39 may be located in a dedicated database server. In addition, any of the components or sub-components may be executed in one or multiple computer systems.

Web pages (or web browsers) can provide additional information to viewers. For example, when a user places a mouse over a link label of a hyperlink, a web browser displays the associated destination URL (e.g., on a status bar of the web browser). As another example, when a user places a pointer over a keyword, the web browser may generate a pop-up dialog box, and display relevant information (e.g., an explanation of the keyword). The process of providing additional information to web page viewers is called augmentation.

A keyword (or phrase) often has multiple aspects of related information, each having multiple aspects of related information. For example, the key phrase “digital camera” is related to its history, underlying technology, and available products and services. A specific product related to digital camera has related information such as product description, customer review, and competing products. Usually only one aspect of the related information is provided through augmentation due to limited display space.

Multiple aspects of related information can be arranged and provided to viewers through layered augmentation. Each aspect of related information can be assigned to one specific layer of the layered augmentation. Viewers can navigate among the multiple aspects of related information by accessing the different layers of the layered augmentation without leaving the web page. For example, the augmented information can be displayed in a multi-layered dialog box. A viewer can navigate among different layers by selecting associated tabs displayed in the dialog box in which each tab is associated with a layer. Alternatively, the multiple layers may be stacked in a manner similar to windows in Microsoft Windows™ Operating System. The stacked layers may be arranged in a horizontal, vertical, or cascade style, showing a small exposed portion of each layer, such as a title area or a corner area. Navigation between each layer in the stack can be through selection of that small exposed portion of the layer within the stack. The process of providing additional information (or resources) through multi-layered dialog box and the multi-layered dialog box are collectively called layered augmentation.

FIGS. 3A through 3C are flowcharts collectively illustrating an example process (or method) for augmenting web pages and providing viewers of augmented web pages with related advertisements through layered augmentation. In one embodiment, the illustrated method (or either of its sub-methods 300, 350, and 390) is implemented in a computing environment such as the computing environment 100. One or more portions of the method may be implemented in embodiments of hardware and/or software or combinations thereof.

By way of example, the illustrated method may be embodied through instructions for performing the actions described herein and such instrumentations can be stored within a tangible computer readable medium and are executable by a processor. Alternatively (or additionally), the illustrated method may be implemented in modules like those in the augmentation server 110 described above with respect to FIG. 2 and/or other entities such as the content providers 120 and/or the client computers 130. Furthermore, those of skill in the art will recognize that other embodiments can perform the steps of the illustrated method in different order. Moreover, other embodiments can include different and/or additional steps than the ones described here.

FIG. 3A illustrates an example process (or method) 300 for augmenting web pages. As illustrated in FIG. 3A with reference to components of the augmentation server 110 in FIG. 2, at an appropriate starting terminus 10, the method 300 begins by reading a piece of structured data from a source data file 30 at a block 13 (e.g., through the handler 36). The source data file 30 may be one designated by an input uniform resource locator (URL) address or by any suitable means to designate a resource. Upon opening the source data file 30, the method 300 may optionally identify the type of content on the page with a content identifier such as a MIME header (e.g., through the locator 42). In one embodiment of the invention, the method 300 merely searches for the presence of a piece of reference data (e.g., through the locator 42), either informed by the content identifier or by simply searching an occurrence of a piece of well structured data (e.g., a keyword) within the source data file. In addition, once the source data file 30 is open, the method 300 has its content available for comparison to reference data in the reference database 39. Other methods and examples to read a piece of structured data from the source data file are described in U.S. application Ser. No. 12/033,539, filed on Feb. 19, 2008, the content of which is incorporated by reference in its entirety.

At a block 16, the method 300 locates one or multiple pieces of reference data in the reference database 39 corresponding to the piece of structured data read in the source data file 30 (e.g., through the locator 42). In one embodiment, the locator 42 searches for reference data in the reference database 39 that match the piece of structured data by making function calls to the reference database 39. In one embodiment, the structured data are keywords, and the reference data also contain keywords.

Keywords are a facile and efficient means of generating layered augmentation. In addition to or instead of using keywords, one embodiment uses a “fuzzy expert” or a neural network analysis of the source data file 30, such as by a natural language search of the source data file 30 to generate a distinct identifier for the content in the source data file 30. One advantage of a natural language search is the ability to better place content in context making links more contextually appropriate, for instance, security might relate to security of a physical plant such as security of a residence in one source data file 30 in one context and security of a website in another. In one embodiment, the method 300 determines a context of the keywords and/or the source data file 30 based on statistical modeling (e.g., through the locator 42). For example, a context can be assigned a pre-defined set of terms which acts as a fingerprint for the context (hereinafter called context fingerprint). The locator 42 can compare the context fingerprints associated with a collection of contexts with the terms within the source data file 30 to determine a percentage match for each context in the collection. Where a high percentage match is achieved (e.g., exceeding a pre-defined percentage match threshold), the locator 42 determines that the associated context is the context for the source data file 30. Alternatively or in conjunction, the locator 42 may determine the context associated with the highest percentage match as the context for the source data file 30. The context can be used to locate corresponding reference data and/or related resources.

At a block 19, the method 300 generates an association to the piece of structured data based upon the located matching reference data (e.g., through the analyzer 45). In one embodiment, a piece of reference data includes an identifier such as a keyword, a context, a unique identification number, and/or associated URL address(es) of intended destination resource(s) based upon the occurrence of the corresponding keywords in the source data file 30. Generating an association means to associate the piece of structured data located in the source data file 30 with the located reference data in the reference database 39. The generated association might optionally include additional identification codes such as an association ID. The method 300 then augments the original source data file 30 with the generated association at a block 22 to generate an augmented data file 50 (e.g., through the generator 48).

In one embodiment, the method 300 expresses the association as intelligent tags (e.g., through the generator 48). The method 300 generates intelligent tags for the located keywords and tags the keywords with the generated intelligent tags. The intelligent tags contain information about the associated keywords such as the keyword and related context, and information about the associated reference data such as IDs that uniquely identify the reference data in the reference database 39. For example, the intelligent tags may contain requirement (or preference) information about advertisements (or other types of resources) to be associated with the keyword, such as types of advertisements and a minimum advertisement fee. In one embodiment, the intelligent tags also format the augmented keywords differently than the other textual content in the augmented web pages. Having generated the augmented data file 50, the method 300 then terminates at a block 25.

In one embodiment, the augmentation server 110 (or the content providers 120) also augments the web pages by including computer code (hereinafter called client code) to monitor and report viewers' interactions with the augmented keywords. The computer code can be in any computer language, such as JavaScript. Additional functions of the client code are described in detail below with respect to FIGS. 3B and 3C.

The augmented data file 50 can be delivered (or transmitted) to client computers 130 for display through a web browser to viewers to provide related resources through layered augmentation. The delivery of the augmented data file 50 and the process to provide layered augmentation is described in detail below with respect to FIGS. 3B and 3C. For purpose of illustration, the method is described in terms of web pages augmented with advertisements, even though the disclosed embodiments apply to other types of augmented data file and resources.

Referring now to FIG. 3B, a flowchart illustrating an example process (or method) 350 for providing layered augmentation to viewers of augmented web pages. As illustrated, the method 350 transmits 355 an augmented web page to a client computer. For example, a user of the client computer 130 may enter the URL of an augmented web page (or the corresponding original web page) in the address bar of a conventional web browser (e.g., Microsoft Internet Explorer™, Mozilla Firefox™, or Apple Safari™)

The web browser of the client computer 130 (hereinafter called the client web browser) resolves the URL and transmits a request for the web page to a corresponding content provider. Responding to the request, the content provider transmits 355 the augmented web page to the client web browser for display. In one embodiment, the client web browser displays augmented keywords in a double underline style and/or in a color distinctive from text that is not augmented in the augmented web page.

The method 350 receives 360 an intelligent tag request from the client computer 130. As described above with respect to FIG. 3A, the augmented web page contains client code that monitors user interactions with augmented keywords. In one embodiment, if the user moves a pointer (e.g., a pointer controlled by a mouse, navigation button, or touchpad) over (a mouse-over) an augmented keyword (the activated keyword), the client code (which may be integrated with the web browser, for example, as a plug-in applet) generates an intelligent tag request and transmits the request to the augmentation server 110. The request indicates the mouse-over user activity to the augmentation server 110. The request may contain information that uniquely identifies the activated keyword (e.g., an association ID), and/or other information such as the activated keyword itself.

The method 350 determines 365 advertisements relevant to the activated keyword for the received request based on the keyword and/or the associated reference data. In one embodiment, the augmentation server 110 extracts the keyword and/or related context from the request, retrieves the associated reference data from the reference database 39, and determines 365 the relevant advertisements by searching in an advertisement database using the keyword and/or requirements set forth in the associated reference data (e.g., advertisement category, context, fee requirements, etc.).

In one embodiment, the method 350 determines 365 the advertisements that match the best (e.g., matching the activated keyword and/or satisfies the most number of reference requirements) as the relevant advertisements. In another embodiment, the method 350 determines 365 relevant advertisements based on a context of the augmented web page and/or the activated keyword. For example, for a key phrase “digital camera” in an article about digital camera, the method 350 may determines the following resources as relevant: a product review of a digital camera in CNET.com, a collection of user reviews at Buy.com, and a selection of similar digital cameras. The context can be determined when the activated keyword is identified in method 300.

In one embodiment, the method 350 determines a sequence for the related advertisements. The top advertisement in the sequence (also called the default advertisement or the primary advertisement) is the advertisement being displayed on the top layer of the layered augmentation. The lower ranked advertisements (also called secondary advertisements) are made available on lower layers of the layered augmentation. In one embodiment, the method 350 uses a bidding system to determine related advertisements sequence. For example, for a key phrase “digital camera,” there may be multiple related advertisements (e.g., advertisements for different brands or models of digital cameras), each having a bid (or budget or cost) for the key phrase. The method 350 may determine a sequence of the advertisements based on their bids, the one with the highest bid ranked the highest and so on.

In another embodiment, the method 350 may determine the sequence of multiple advertisements based on factors other than bidding prices. For example, the method may consider factors such as relationships among the multiple advertisements (e.g., prioritizing video advertisements over text ones), prior user interactions with the advertisements (e.g., prioritizing advertisements with higher interacting rate), and contexts of the augmented keyword (e.g., prioritizing advertisements from retailers or service providers having branches near a geographical context of the keyword and/or the augmented web page, or geographic locations of a substantial portion of viewers of the web page).

Further, specific sequences may be set for specific keywords and/or parties (e.g., content providers, advertisers, users). For example, if the keyword(s) is a music artist (or band, album) name, the method 350 may make available his songs (e.g., playback through an embedded music player) on the top layer and other resources on lower layers. As another example, if the keyword(s) is a location name (e.g., Yellowstone National Park), the method 350 may make available the relevant map (e.g., MapQuest™ Map) on the top layer. As noted above, the resources made available through the layered augmentation need not to be advertisements and can be related contents such as related articles, videos, images, music, to name only a few. For example, a content provider may specify that the layered augmentations in its web pages make available a set of links to its other relevant web pages (e.g., within the same website) where the keyword(s) being augmented is cross-indexed.

In one embodiment, viewers can set their preferences to determine a preferred sequence for the layered augmentation. For example, a viewer may prefer video advertisements while another may disfavor them (e.g., due to bandwidth constrains at receiving device). As a result, the method 350 may place video advertisements higher on a sequence for the first viewer, while not consider video advertisements for augmentation for the second viewer. Viewer preferences can be stored in a database such as the reference database 39 along with other viewer related data (e.g., profile data).

The method 350 transmits 370 the relevant advertisements to the client computer 130 for display. In one embodiment, the method 350 retrieves the advertisements from an advertisement database, and transmits 370 them to the client web browser (or the client computer) for display. Alternatively, the method 350 may transmit references of the advertisements (e.g., their URLs) to the client web browser for retrieval.

In one embodiment, the method 350 generates computer code (hereinafter called the advertisement code) to facilitate user interaction with the advertisements. Similar to the client code, the advertisement code can be in any computer language, such as JavaScript. The advertisement code may display the relevant advertisements in a multi-layered dialog box (or popup box) when the viewer moves a pointer over the activated keyword. The method 350 transmits the generated advertisement code along with the related advertisements to the client web browser. In one embodiment, the advertisement code is a part of the client code, and is integrated in the augmented web page when the page is generated

The client web browser displays 375 the relevant advertisements in a layered dialog box proximate to the activated keywords (or the position where the mouse-over is occurring) as an in-page overlay. In one embodiment, the client web browser utilizes the advertisement code to display the advertisements in a multi-layered dialog box. The advertisements are displayed according to their sequence. In one embodiment, only the top advertisement is displayed and the lower ranked advertisements are represented by selectable tabs. An example process of the operation of the advertisement code and the client code is described in detail below with respect to FIG. 3C.

Referring now to FIG. 3C, a flowchart illustrating an example process (or method) 390 of the client code and/or the advertisement code. As illustrated, the method 390 determines whether a pointer is positioned over an augmented keyword (the activated keyword), and if so, sets 392 the primary advertisement as the active advertisement, and displays 394 the active advertisement in a multi-layered dialog box overlaying the augmented web page in a position proximate to the activated keyword or the mouse-over. The multi-layered dialog box also displays multiple selectable (e.g., clickable) tabs representing the lower layers. The viewer can select a tab to request the multi-layered dialog box to display the corresponding layer. If the user selected a tab, the method 390 sets 396 the advertisement corresponding to the selected layer as the active advertisement and displays 394 it in place of the previously displayed advertisement.

The viewer can also interact with the currently displayed advertisement by selecting the advertisement. If the viewer selects the advertisement, the method 390 responds 398 to the user selection based on the nature of the user selection and the configuration of the advertisement. For example, if the user clicks on the active advertisement, the method 390 redirects the web browser to a web page related to the active advertisement. Alternatively, if the user drags a scrollbar displayed on the dialog box, the method displays different portions of the active advertisement as the user drags along the scrollbar. In one embodiment, if the viewer moves the pointer away from the activated keyword and/or the multi-layered dialog box for an extended period of time, the method 390 hides the dialog box.

Referring back to FIG. 3B, in one embodiment, rather than displaying multiple advertisements, the method 350 displays multiple aspects (or portions) of the same advertisement in the multi-layered dialog box. For example, the multi-layered dialog box may display an image and brief description of a product, and present two tabs, one for user reviews and the other for playback of a television advertisement of the product. The viewer may interact with the advertisement through the multi-layered dialog box without having to navigate away from and otherwise leave the current web page the viewer is interacting with in the web browser. For example, if the advertisement contains video, the multi-layered dialog box may overlay the video with video controls (e.g., forward, rewind, play/pause, volume, etc.). The multi-layered dialog box may also provide functional resources such as web searches, enabling viewers to conduct web searches and/or review search results without leaving the augmented web page.

The method 350 tracks 380 the received requests, the advertisements displays, and/or the user's interactions with the advertisements. These activities may be logged in a database (e.g., the reference database 39) or reported to another device or person (e.g., via electronic mail).

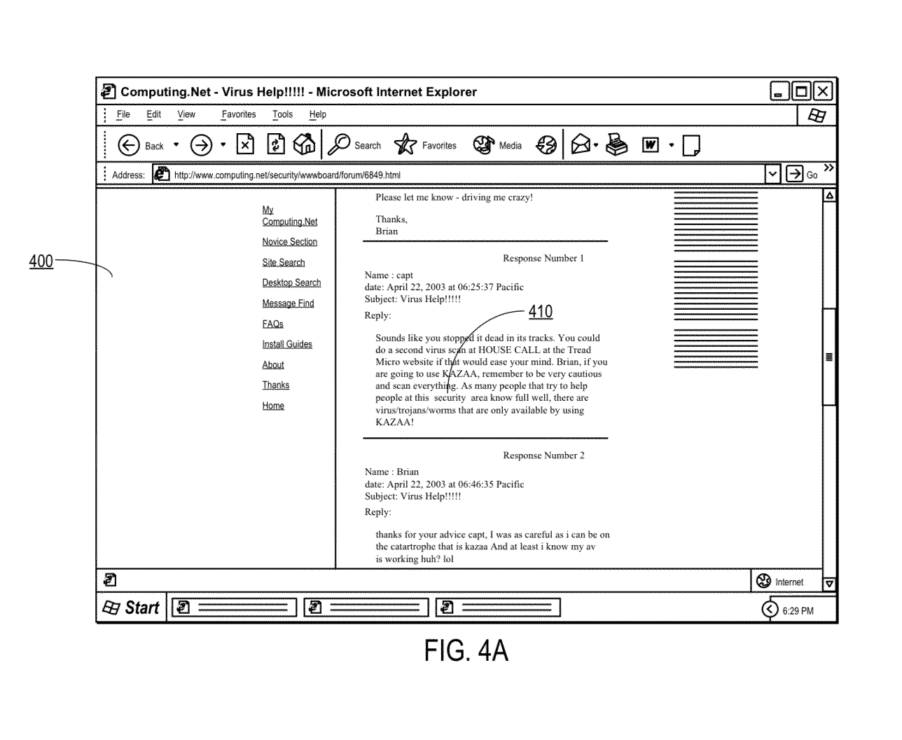

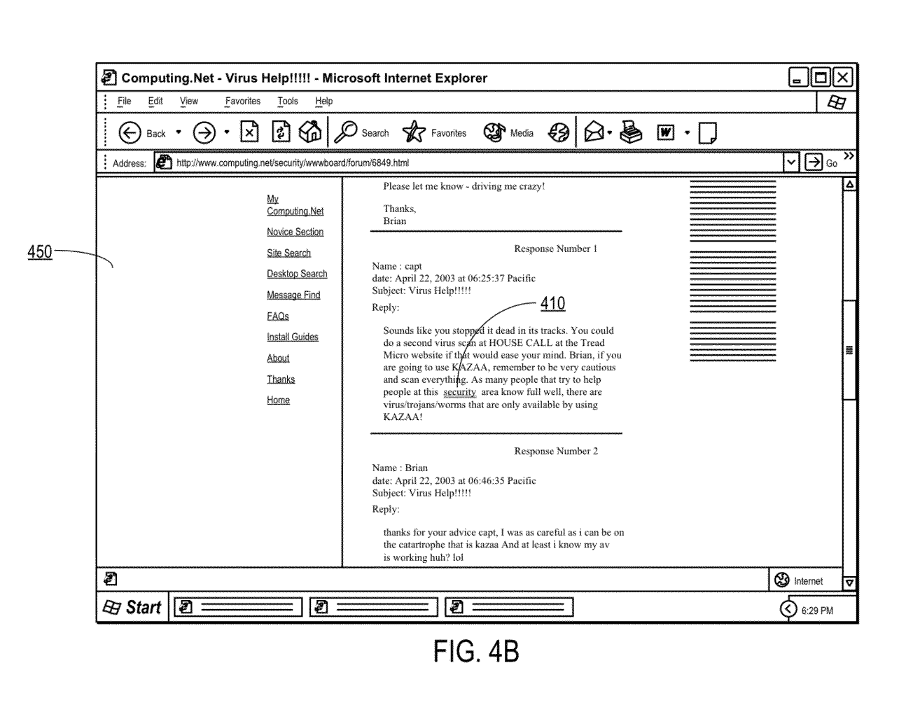

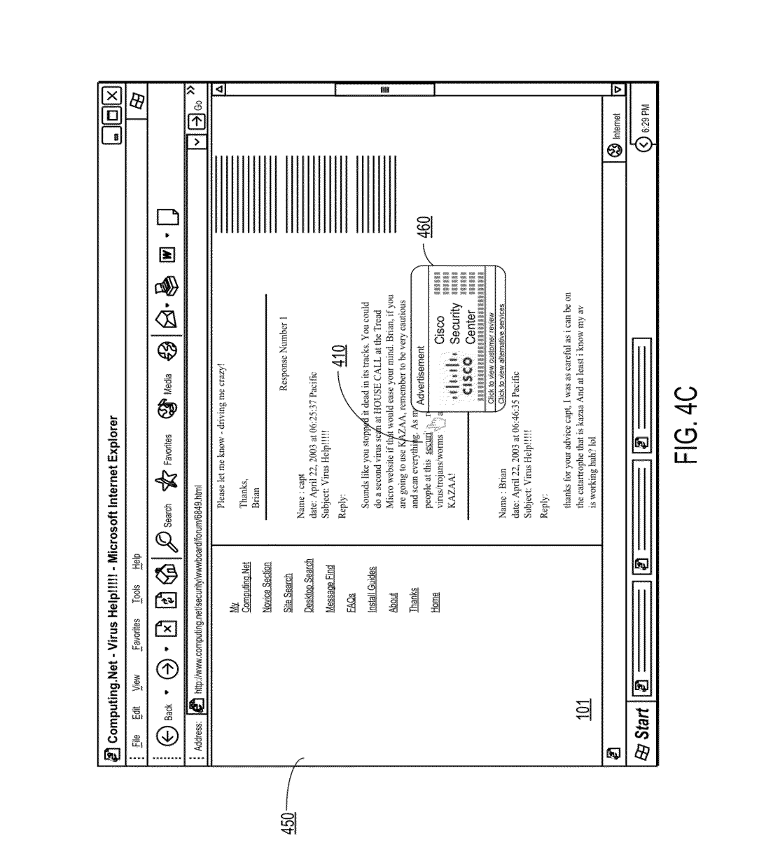

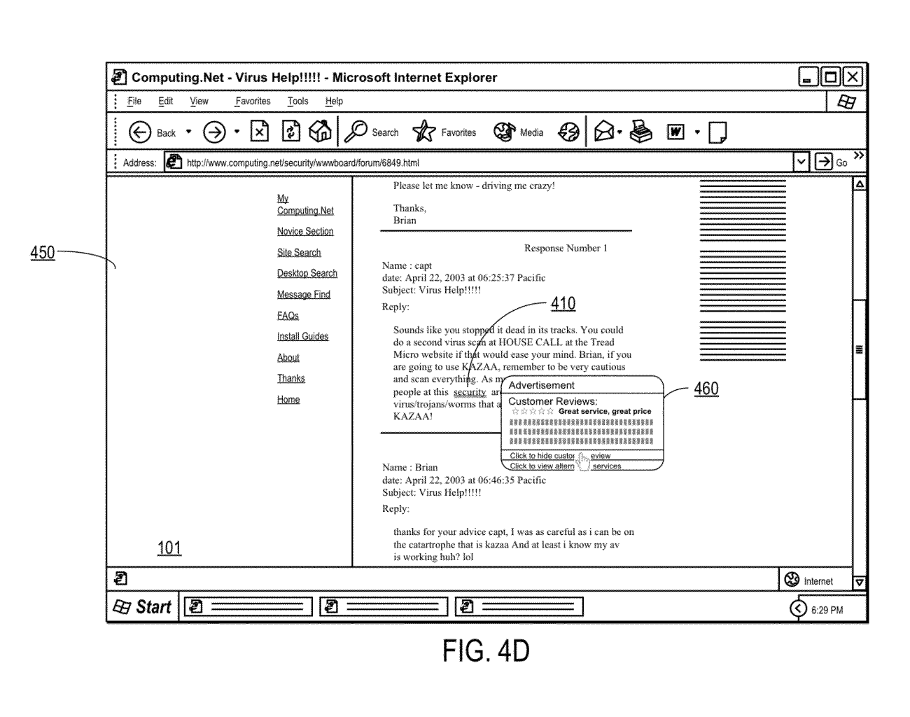

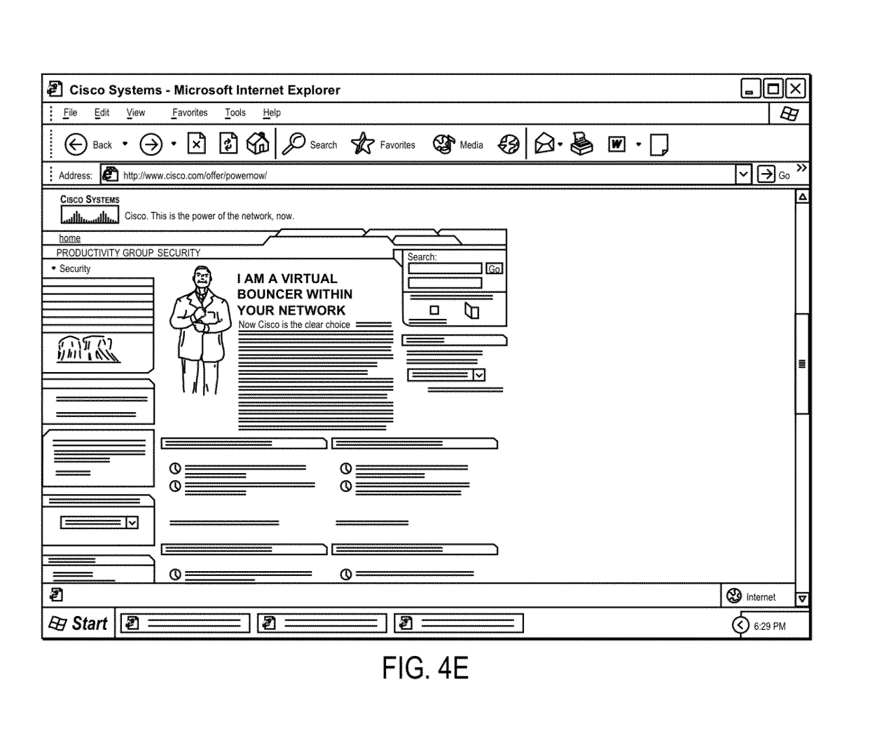

The methods described above with respect to FIGS. 3A through 3C are illustrated below in an example together with accompanying screenshots in FIGS. 4A through 4E. Initially, the augmentation server 110 retrieves a web page 400 for augmentation. The web page 400 may contain textual content of any subject. FIG. 4A shows an example of the web page 400 as displayed in Microsoft Internet Explorer™ As shown in FIG. 4A, the web page 400 is retrieved from website www.computing.net and contains a paragraph about computer virus.

The augmentation server 110 reads 13 the web page 400 for keywords. The augmentation server 110 identifies the keyword “security” 410 for layered augmentation. The augmentation server 110 locates 16 a piece of reference data matching the keyword “security” 410 and determines a context of computer security for the keyword 410. The piece of reference data includes an advertisement category for computer security services. The augmentation server 110 generates 19 an association of the keyword “security” 410 and the located piece of reference data.

The augmentation server 110 augments 22 the web page 400 by generating an intelligent tag encoding the generated association, and integrating the intelligent tag in an augmented web page 450. The augmentation server 110 also includes in the augmented web page 450 JavaScript code (client code) that captures user interactions with the augmented keyword 410.

A web browser running on a client computer 130 retrieves the augmented web page 450 and displays it to a user (e.g., responding to the user entering an URL of the web page 400 or 450 in the address bar of the web browser). FIG. 4B illustrates a screenshot of the augmented web page 450 as displayed on an Internet Explorer™ web browser after it is retrieved by the browser. It is noted that in FIG. 4B the augmented keyword 410 is displayed in a double underline style to distinguish from conventional hyperlinks that are single underlined.

Subsequently, the user may move a pointer (e.g., controlled by a mouse, stylus, or touchpad) over the double underlined augmented keyword 410 (the activated augmented keyword). This user action is also referred to as a mouse-over. Detecting the mouse-over, the embedded JavaScript code (the client code) in the augmented web page 450 (or the web browser) generates an intelligent tag request that uniquely identifies the activated augmented keyword 410 and/or the related context, and transmits the request to the augmentation server 110. The augmentation server 110 receives 360 the request, retrieves stored association of the keyword 410, and determines 365 relevant advertisements by searching for advertisements corresponding to the keyword 410 and/or the related context in an advertising database. In the present example, the augmentation server 110 determines 365 that an advertisement for Cisco security center is the relevant advertisement associated with the augmented keyword 410.

The augmentation server 110 determines a sequence of various parts of the Cisco advertisement and/or other relevant advertisements. In the present example, the augmentation server 110 determines that a description of the Cisco security center ranks top in the sequence, followed by its customer reviews, and a list of competing services.

The augmentation server 110 transmits 370 the related advertisement(s) back to the web browser for display. The augmentation server 110 also transmits JavaScript code (advertisement code) that enables layered representation of the transmitted advertisements.

The web browser (or the advertisement code) displays 375 the received advertisement(s) as an overlay in a multi-layered dialog box in proximity to the keyword 410 or the location where the mouse-over occurred. As illustrated in FIG. 4C, the user has moved a mouse pointer over the keyword 410. As a result, the web browser receives advertisements related to the keyword “security” 410 and displays them in a multi-layered dialog box 460 proximate to the pointer.

As illustrated, the multi-layered dialog box 460 displays an advertisement about CISCO security center. On the bottom of the multi-layered dialog box 460 are two tabs labeled “Click to view customer review” and “Click to view alternative services,” respectively. Note that this is consistent with the sequence of the advertisements (and/or advertisement portions) determined by the augmentation server 110. The user can navigate the advertisements within the multi-layered dialog box 460 by clicking the labeled tabs. The user can also visit the corresponding advertiser's web page by clicking the advertisement. While the user navigates within the multi-layered dialog box 460, the augmented web page 450 remains as the current web page displayed in the client web browser. The user can quickly resume browsing the rest of the augmented web page 450.

As illustrated in FIG. 4D, when the user clicks (or mouse-over) the tab labeled “Click to view customer review,” the multi-layered dialog box 460 displays customer reviews for Cisco security center. It is noted that the label on the tab representing customer review changes to “Click to hide customer review.” The user can click the tab to resume viewing the previous advertisement for Cisco security center.

As illustrated in FIG. 4E, when the user clicks the Cisco security center advertisement, the advertisement code redirects the client web browser to the advertiser's web page, in this case a web page related to Cisco security center.

C. Systems and Methods of an Ad Server Platform

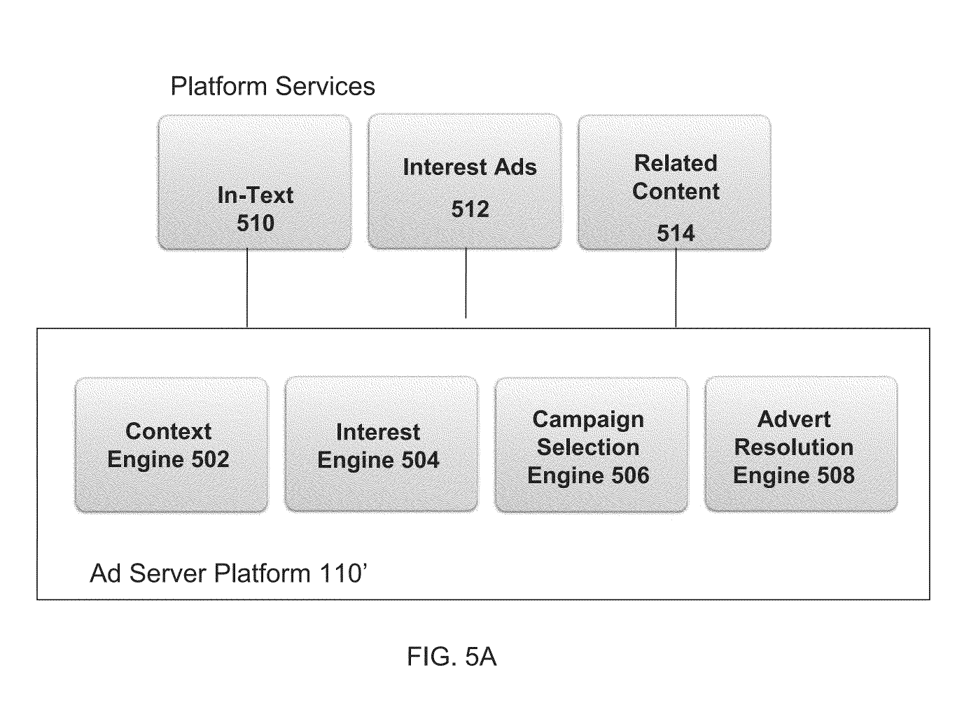

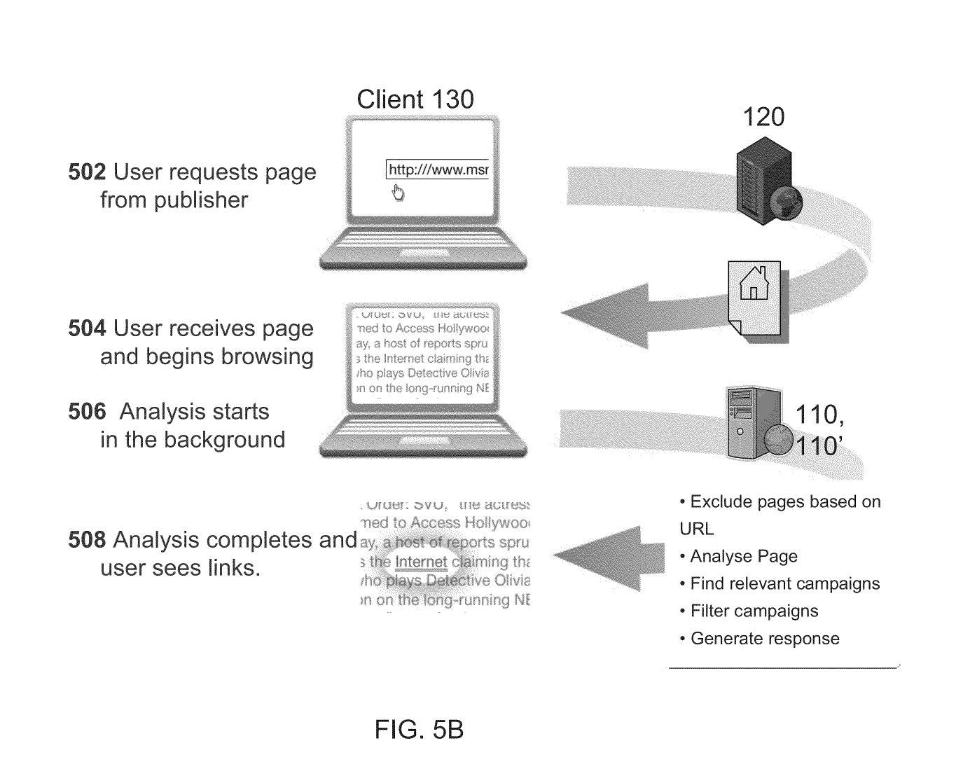

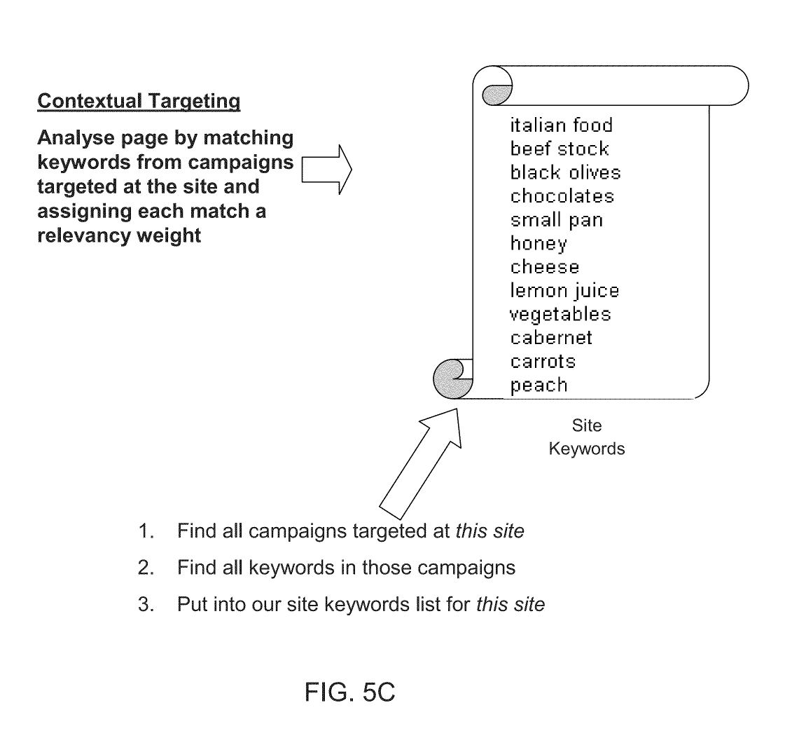

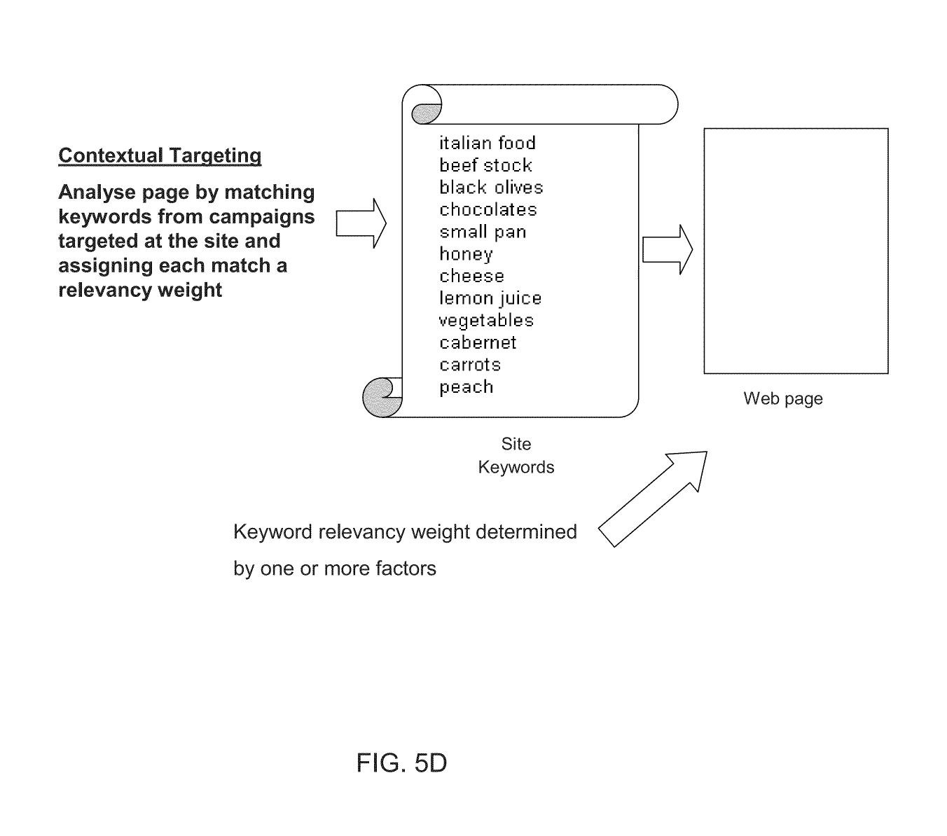

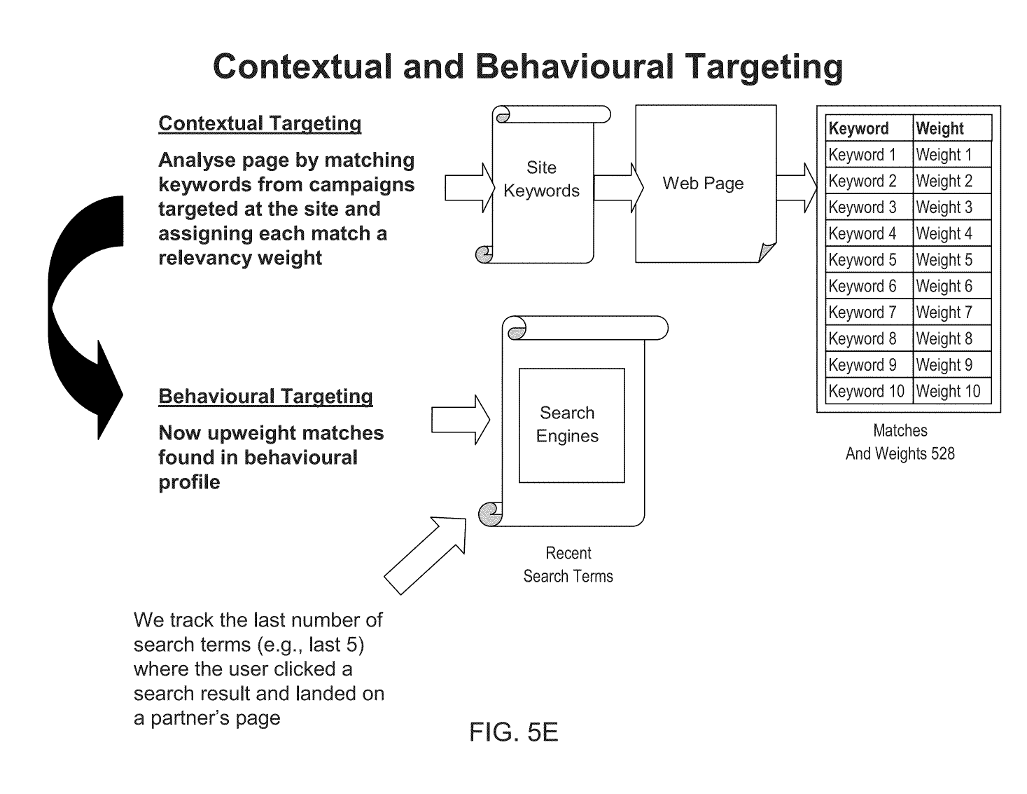

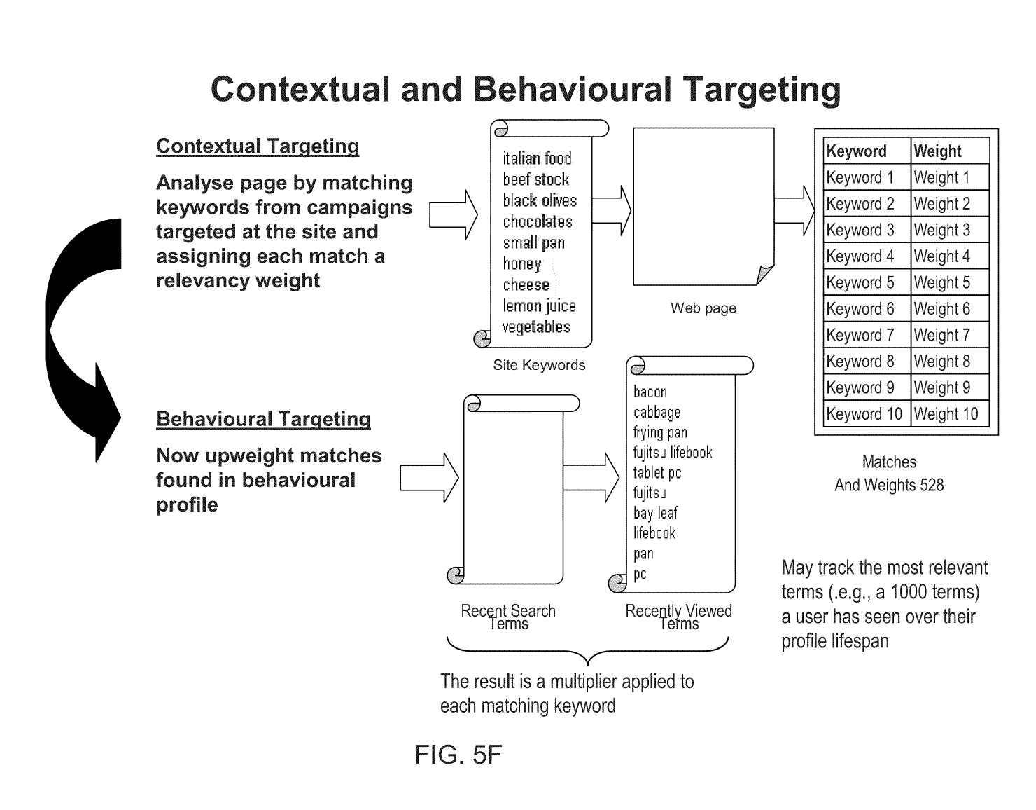

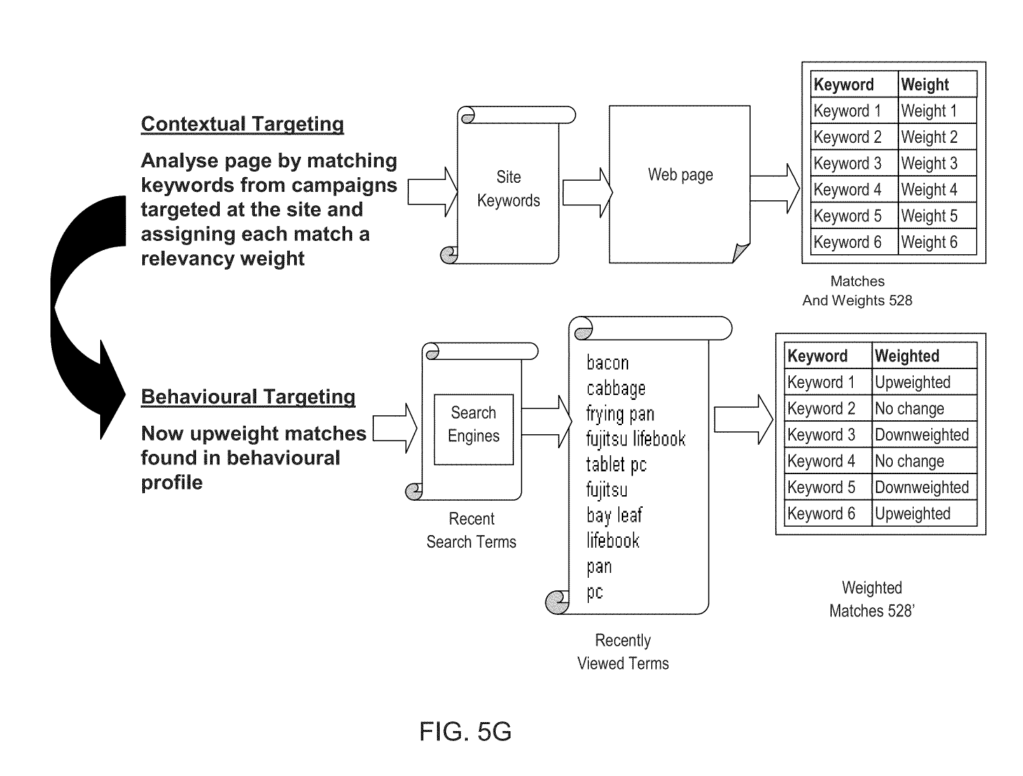

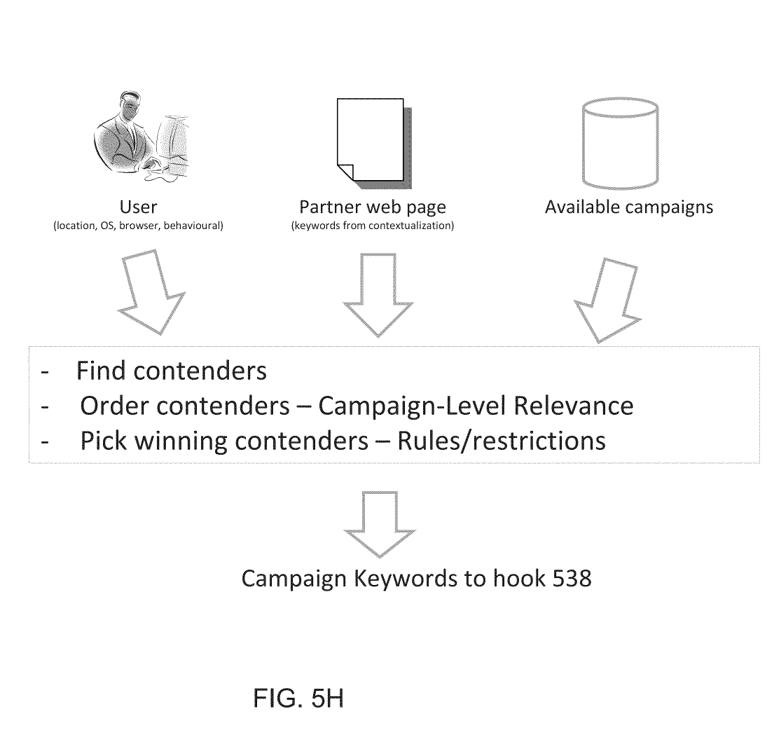

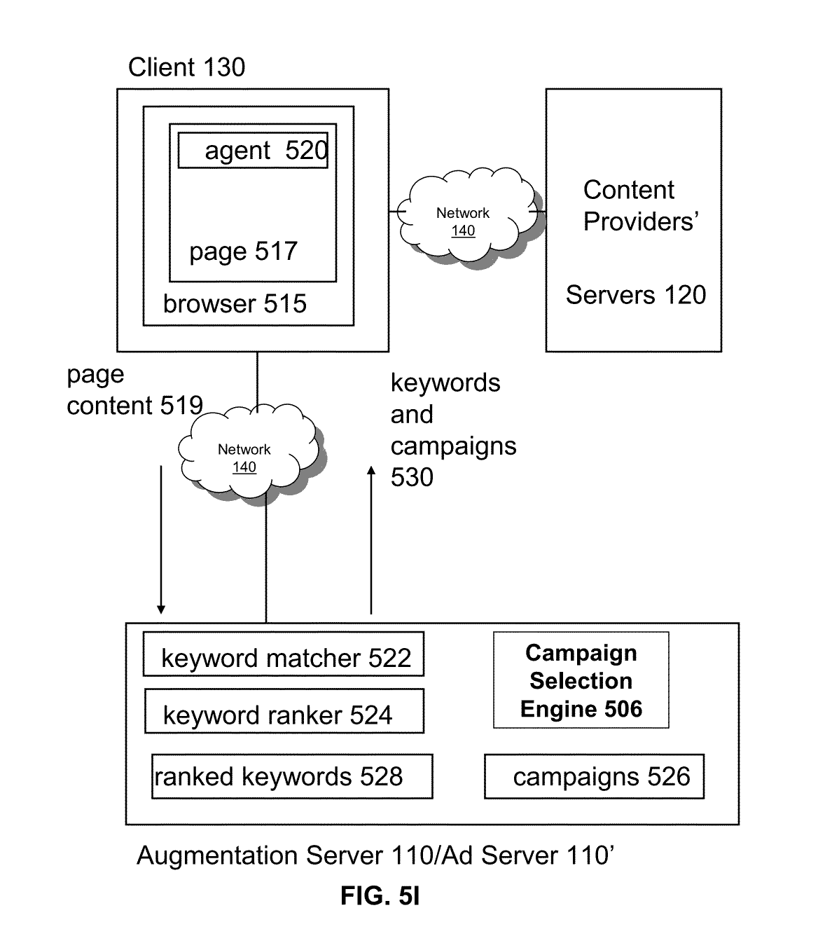

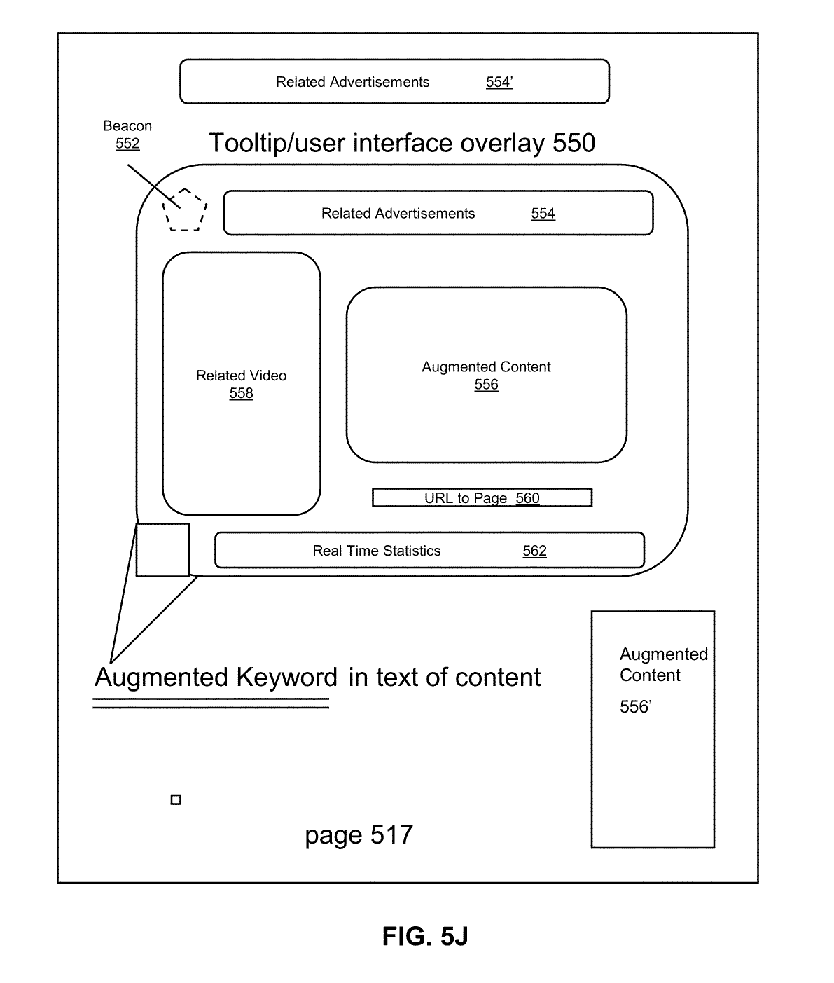

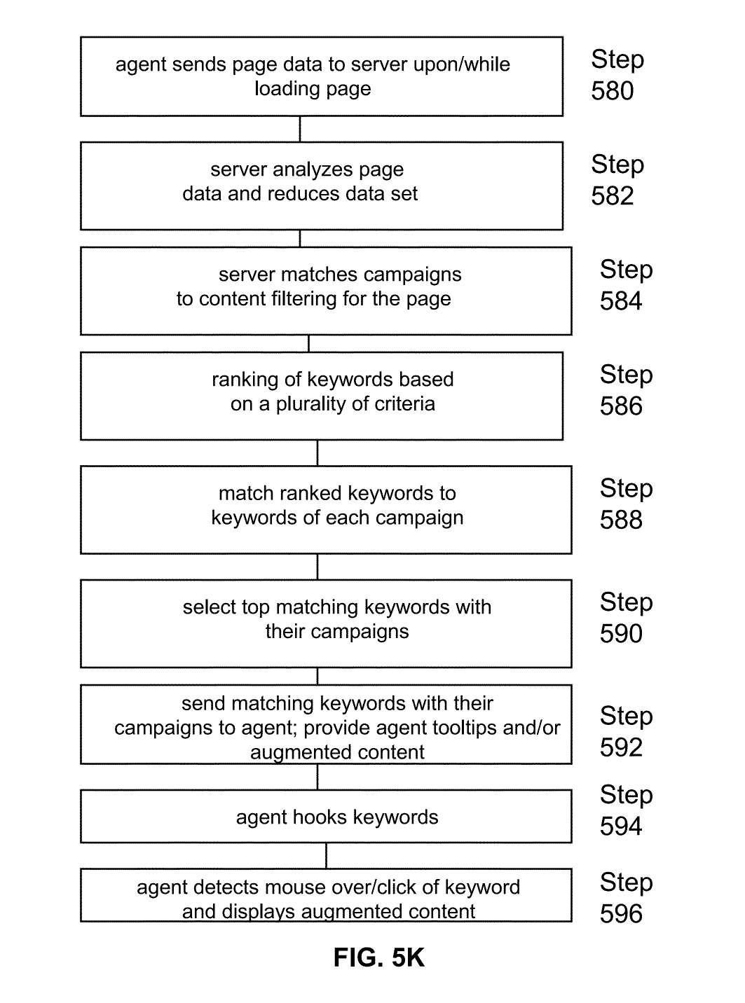

Referring now to FIG. 5A, an embodiment of an environment and systems for providing a plurality of augmented content and related services. In brief overview, an ad server platform 110′ delivers a plurality of services, such an in-text services 510, interest ads 512 and related content 514 services. The ad server platform 110′ may include a context engine 502, an interested engine 504, a campaign selection engine 506 and/or an advert resolution engine. The ad server may include or further include any embodiments of the augmentation server 110 described herein.

The ad server platform 110′ may comprise any combination of modules, applications, programs, libraries, scripts or any other form of executable instructions executing on one or more servers. The ad server platform 110′ may provide services directed to advertisers to reach a plurality of users across a plurality of publisher websites, such as content providers 120. The services of the ad server platform 110′ may combine the precise word targeting with delivery of rich media and video content. The ad server platform 110′ may provide services directed to publishers to received additional advertising revenue and real-estate with adding more clutter on their web-sites. The ad server platform provides a user controlled environment, allowed the user to view augmented content, such as advertising, only when these choose to via mouse interaction over a relevant word of interest—a keyword. As such, an ad impression may be pre-qualified in that a user must choose to view the ad by moving their mouse over or clicking on a word or phrase of interest. This may be referred to as user-initiation impressions.

The ad server platform may provide in-text advertising services 510. In-text services reads web pages and hooks words and word-phrases dynamically and in real time. The hooked words may be linked or hyperlinked to augmented content in any manner. In one embodiments, the words are double underlined but any type of indicator may be used such as a single underline or an icon. In some embodiments, the code for in-text services is installed by publishers into their sites and does not require any additional code, adware or spyware to be downloaded or uploaded by a user. When a user mouses over or clicks on hooked (e.g., double underlined) word or phrase, the code display a user interface overlay, sometimes referred to as a tooltip, on the web page and near the hooked word or phrase.

The ad server platform may provide interest ad services 512. The interest ad services identifies words of interest within a web page to deliver advertisements that are related to these words of interest. The interest ad service may identify the words on the page to analyze those words to determine which words are core or central to that page. These set of core word are keywords to identify one or more ad campaigns relevant to those keywords and the user's interests. This may minimize wasted impressions and deliver and advertising experience that relates more directly to the user's interest.

The ad server platform may provide related content services 514. The related content services may provide, create or generate an automated linking system that conveniently delivers relevant additional content from the same or different publishes in the form of videos, articles and information. The related content services may read web pages and hook words and word-phrases dynamically and in real time. The hooked words may point or navigate the user through content related to the hooked words available through a website, network or portal. For example, the related content service may link a word on the page to re-circulate the user through additional content, such as other web pages, of the publisher. In some embodiments, the related content service may automatically mirror the hyperlink style of a publisher's editorial links or already provided hyperlinks. The related content services may generate or add an icon, such as search icon, that indicates that augmented content is returned or available.

In further details, the ad server platform may comprise one or more context engines 502. The context engine may comprise any type and form of executable instructions executing on a device, such as a server. The context engine may comprise any functions, logic or operations for analyzing content of a web page. The context engine may use any type and form of semantics based algorithm to determine the meaning of the keyword relevant to the content of the page, the user, the web-site, the publisher and/or the campaign. The context engine may determine the intended structure and meaning of words, phrases, sentences or text in the content of the page. The context engine may analyze the text in the content to determine any characters, text, strings, words, terms and/or phrases, or any combinations thereof, that match or correspond to any characters, text, strings, words, terms and/or phrases, or any combinations thereof of any one or more campaigns. The context engine may analyze the content of the page for keywords from campaigns targeted at the web-site, publisher or content provider of the page. The context engine may determine any type of metrics on the content of the web page and of keywords of targeted campaigns of the web page. The context engine may use any type and form of algorithm to determine a keyword relevancy weight such as by location of the keyword, the frequency of the keywords and the length of the keyword. For example, for location weighting, those keywords that appear earlier in the content may be considered more relevant than those that appear later. For frequency relevancy, the more a keyword is repeated within the content, the more relevant the keyword may be considered. For length relevancy, the more words in a keywords the less generic the keyword may be and the more relevant the keyword may be considered.

The ad server platform may comprise one or more interest engines 504. The interest engine may comprise any type and form of executable instructions executing on a device, such as a server. The interest engine may comprise any functions, logic or operations for tracking and storing user information and/or behavior to a behavioral profile. The interest engine may track and store the user's location, operating system and/or browser. The interest engine may track a predetermined number of keywords a user has seen over a certain time period. The interest engine may track a predetermined number of relevant terms a user has viewed over a certain time period. The interest engine may track the a predetermined number of searches for which a user clicked a search result and landed on the content providers web-site or web. The interest engine may store the recent search terms and/or recently viewed terms into a behavioral profile for the user. The ad server platform, context engine and/or interest engine may change the weighting of keywords in content of a page responsive to any information stored in any behavioral profiles. For example, The ad server platform, context engine and/or interest engine may use a multiplier to up weight or down weight one or more keywords.

The ad server platform may comprise one or more campaign selection engines 506. The campaign selection engine may comprise any type and form of executable instructions executing on a device, such as a server. The campaign selection engine may comprise any functions, logic or operations for selecting or matching a campaign to a set of one or more keywords identified and/or weights for content of a page. The campaign selection engine may identify and select a campaign from a plurality of campaigns. The campaign selection engine may identify and select a first set of campaigns from a plurality of campaigns that meet a first threshold or criteria. From the first set of campaigns, the campaign selection engine may order or rank these campaigns using any type and form of algorithms. In some embodiments, the campaign selection engine may provide a campaign-level relevance of the keywords. The campaign selection engine may determine a relevance number or weighting for each campaign relative to the weighted keywords. In some embodiments, each campaign may provide a priority to keywords, web-pages or publishers. In some embodiments, each campaign may provide a relevance weighting to keywords, web-pages or publishers. The campaign selection engine may also comprise any set of one or more rules or restrictions for either changing the ranking, keeping a campaign or removing the campaign. Based on applying these rules and/or restrictions, the campaign selection engine selects from the first set of one or more companies a second set of one or more campaigns to use for augmenting the identified keywords on the web-page.

The ad server platform may comprise one or more advert resolution engines 508. The advert resolution engine may comprise any type and form of executable instructions executing on a device, such as a server. The advert resolution engine may comprise any functions, logic or operations for resolving the advertisement to use for a hook. For each advertisement, the advert resolution engine may determine whether the advertisement is a backfill or to be obtained from a backfill network. If the advertisement is backfill, the advert resolution engine calls or communicates with the backfill provider's servers. For example, the advert resolution engine may include one or more handlers designed and constructed to communicate with a particular backfill provider. When an advertisement is received from the backfill provider or when the advertisement if not coming from a backfill, the advert resolution engine may perform any type and form of filtering on the advertisement, such as for making sure the ad meets any rules or restrictions for content. The advert resolution engine includes a placer for selecting an instance of a keyword to hook with the advertisement. When the advert resolution engine has checked for backfill, filters the advertisement and selected an instance to hook for all the intended advertisements, the advert resolution engine may hook the keywords. The advert resolution engine may perform these operations for content other than advertisements, such as other types of augmented content.

Referring now to FIGS. 5B through 5H, diagrams of embodiments of the functionality and operations of the ad server platform are depicted. FIG. 5b depicts an embodiment of high level overview of the process from the client perspective. FIG. 5C depicts an embodiment of contextual targeting. FIG. 5D depicts an embodiment of keyword relevancy weighting. FIG. 5E depicts an embodiment of behavioral targeting. FIG. 5F depicts a further embodiment of behavioral targeting. FIG. 5G depicts an embodiment of further weighting based on behavioral targeting. FIG. 5H depicts and embodiment of campaign selection.

Referring to FIG. 5A, at step 502, a user on a client 120 requests a page from a publisher, such as a web page of a content provider 120. At step 504, the client receives the page and the browser loads the page. The user may start browsing the web page. At step 506, an agent on the page, such as a script starts an analysis in the background. The agent may be triggered upon loading of the web page or start the analysis upon receipt and/or loading of the web page. The agent may communicate with the ad server platform to perform any of the services of in-text advertising, related content or interest ads. For example, the agent may send content from the page for the ad server platform to analyze. In the background of the user viewing or browsing the web page, the ad server platform may analyze the page, find relevant campaigns filter campaigns and generate a response to the agent for hooking the keywords and identifying or delivering the augmented content. The ad server platform may not analyze pages based on filtering certain URLs. The ad server platform may analyze the content received from the agent, perform any of the services described herein and send the keywords to hook and the corresponding augmented content, such as advertisements from a campaign. At step 508, the analysis is completed and the user sees links to keywords, such as double underlined keywords. As described herein, the user may mouse over or click the hooked keyword and have the augmented content displayed.

Referring now to FIG. 5C, an embodiment of contextual targeting is depicted. This contextual targeted may be performed by the ad server platform and performed in the background while the page is being loaded and browsed/viewed by the user. The ad server platform receives page content from the client, such as via an agent. The ad server platform analyzes the page to match keywords to campaigns targeted to the web-site, page or URL. In some embodiments, the ad server platform finds all campaigns targeted to this site, finds all keywords in those campaigns and forms or generates a site keyword list for this site. The ad server platform may match the keywords from the site keyword list to keywords in the content from the page. The ad server platform may assign each matching keyword a relevancy weight.

Referring now to FIG. 5D, an embodiment of assigning a relevancy weight to each keyword to provide contextual targeting is depicted. The ad server platform may provide a relevancy weight to each keyword of the site keyword list matching content of the web page. The ad server platform may use any type and form of metrics or combinations of metrics to determine a relevancy weight. In some embodiments, the ad server platform uses a location, frequency and/or length metric to assign a relevancy weight to the matching keyword. The location relevancy weight may comprise an indicator or multiplier to those keywords that appear near the beginning or top of the web page relevant to those keywords that appear near the end of bottom of the web page. The frequency relevancy weight may comprise an indicator or multiplier to those keywords that appear more times on the same page or content than other keywords. The length relevancy weight may comprise an indicator or multiplier to those keywords that have more words in the keywords than single keyword or keywords with less words.

Each type of metric relevancy weight may be weighted the same or differently. Each metric relevancy weight may have it owns multiplier or factor that scales the weight for the keyword up or down according to the relevancy. The keyword may be up weighted and/or down weighted one or more times by each of the metric relevancy weights. A keyword relevancy weight may be up weighted by one metric relevancy weight while downloaded by another relevancy weight. For example, a keyword may be repeated several times and be up weighted or have a high multiplier based on the frequency relevancy weight while only found and repeated near the end of the page for a down weighting or low multiplier from the location relevancy weight. In some embodiments, a keyword may get a low relevancy weighting from each of the metric relevancy weightings. In some embodiments, a keyword may get a high relevancy weighting from each of the metric relevancy weightings. In some embodiments, a keyword may get a combination of low and high relevancy weightings from different relevancy weightings.

Referring now to FIG. 5E, an embodiment of applying behavioral targeting is depicted. The ad server platform may identify, track and store formation about a user's behavior in a behavioral profile. The behavioral profile may comprise a profile for one user or a plurality of users. Each of the user's profile data may be identified, tracked and managed via unique user identifiers. In some embodiments, the ad server platform may track a predetermined number of search terms, such as 5, that the user last searched. In some embodiments, the ad server platform may track a predetermined number of search terms for each search engine, such as the Google search engine, Microsoft Bing search engine, Yahoo search or Ask search engine. In some embodiments, the ad server platform may track a predetermined number of search terms for each search engine across a combination of search engines. In some embodiments, the ad server platform tracks and stores those search terms for which the user clicked a search result. In some embodiments, the ad server platform tracks and stores those search terms for which the user clicked a search result. In some embodiments, the ad server platform tracks and stores those search terms for which the user clicked a search result and landed on a web page of a predetermined content provider or publisher.

Referring to FIG. 5F, a further embodiment of behavioral targeting is depicted. The ad server platform may track and store in the behavioral profile of a user a history of terms the user has seen over a predetermined time period. In some embodiments, the ad server platform tracks terms has a user has viewed on a web page. In some embodiments, the ad server platform tracks terms the user has selected from a search or interacted with during the user's viewing history. In some embodiments, the ad server platform tracks terms of one or more search results from which the user has clicked through. In some embodiments, the ad server platform tracks viewed terms over a predetermined time period. In some embodiments, the ad server platform tracks viewed terms over a start of a behavioral profile of the user to current time.

The ad server platform may use any of the search terms and/or viewed terms from the behavioral profile to make a change to the relevancy weightings of the matching keywords. Those matching keywords that the use has searched or viewed previously will have their relevancy weightings increased or up weighted via a behavioral targeting multiplier. In some embodiments, the ad server platform may use a combination of recently searched and viewed terms to apply a multiplier to each matching keyword. The ad server platform may use any temporal threshold to determine which search terms and/or viewed terms to use for determining a multiplier to the relevancy weightings of the matching keywords. The ad platform may apply higher behavioral targeting multipliers to those keywords that were recently viewed and/or recently search within a predetermined time history. The ad platform may apply no or lower behavioral targeting multipliers to those keywords that were not recently viewed and/or not recently search within the predetermined time history.

As a result of using behavioral profile data and behavioral targeting multipliers, as depicted in FIG. 5G, the ad server platform modifies the relevancy of the matching keywords from the site keyword list. The matching keywords are assigned a first relevancy weighting from the contextual targeting and are modified or changed to a second relevancy weighting from the behavioral targeting. In some embodiments, the ad server platform maintains both the contextual targeting relevancy weightings and the behavioral targeting relevancy weighting for each matching keyword. In some embodiments, the ad server platform maintains a single relevancy weighting keyword comprising the behavioral targeting multipliers (up weighting or down weighting) to the relevancy weighting applied by the contextual targeting.

Referring to FIG. 5H, an embodiment of campaign selection is depicted. In some embodiments, the results of contextual and/or behavioral targeting are used as input to the campaign selection engine. The ad server platform may use the relevancy weightings of the matching keywords from the site keyword list to determine which campaigns may be applicable to these matching keywords. Those campaigns not having keywords corresponding to any of the matching keywords may be dropped from consideration. In some embodiments, those campaigns not having a number of keywords corresponding to the matching keywords within a predetermined threshold may be dropped from consideration. In some embodiments, those campaigns having one or more keywords corresponding to a predetermined number of the top relevancy weighted keywords may be identified for consideration.

The ad server platform may order the list of campaigns under consideration using any type and form of algorithm. For example, the ad server platform may rank the campaigns based on having matching keywords with the highest combined relevancy weightings. the ad server platform may rank the campaigns based on having the highest number of matching keywords. The ad server platform may rank the campaigns based on a combination of the highest combined relevancy weightings and the highest number of matching keywords. The ad server platform may also order campaigns based on any type of priorities assigned to the campaigns. Some campaigns may have a high order of priority to deliver or serve than other campaigns.

The ad server platform may selected the campaigns to deliver from the ordered or ranked list of campaigns. The ad server platform may further restrict the selection based on any rules or policies of the ad server platform, the publisher or the campaign. For example, the campaign or publisher may have rules restricting the serving of a campaign directed to certain users, times of days, locations, browsers, or content. Once the selection of the one or more campaigns is made, the ad server platform generates a list of campaign keywords to hook and transmits these keywords to the agent of the client. The ad server platform may provide to the agent information on the publisher, campaign, tooltip/user interface overlay and/or augmented content with or corresponding to the keyword.

Referring now to FIGS. 5I, 5J and 5K, embodiments of systems and methods for delivering augmented content are depicted. FIG. 5I depicts an embodiment of a system for analyzing content of a page to determine keywords to augment for one or more campaigns. FIG. 5J depicts an embodiment of augmented content delivered to a web page of a client. FIG. 5k depicts embodiments of a method for analyzing and hooking keywords on a web page of a client.

In brief overview of FIG. 5I, an embodiment of a system for augmented keywords on a web page is depicted. A client 130 communicates with one or more content providers 120, such as publishers, via network(s) 140. The client 120 may include a browser that receives, loads and display content in the form of web page or pages 517 from the one or more contents providers. The client 130 also communicates with the augmentation server or ad server 110′. The page 517 being loaded or loaded by the browser comprises an agent 520. The agent 520 may communication page content 519 to the server 110, 110′ for analysis and received from the server 110, 110′ keywords, corresponding campaigns and/or augmented content. The keyword matcher 522 of server 110, 110′ may perform keyword matching, such as using site keyword list, on the page content 519 received from the agent 520. The keyword ranker 524 ranks the keywords to provide ranked keywords 528. The campaign selection engine 506 selects campaigns 526 based on the ranked keywords 528.

In further detail, the browser 515 may comprise any type and form of executable instructions for accessing information resources via a network 140 such as the Internet. The browser may include any user agent or software for retrieving, presenting, accessing and/or traversing information resources or documents on the world wide web or a network 140. The browser may include any functionality for loading, running, processing and/or displaying on a computer screen information written in HTML, XML, JavaScript, java, flash or any other language or a script used for web pages. Browser may include any functionality for displaying any type and form of content or features presented by web page or transmitted content provider 120. Browser may include any functionality for enabling a user to interact or interface with a web page. Browser may provide functionality for displaying advertisement information within a web page presented or displayed on a computer screen of client computer 130. In some embodiments, a browser is any version of Internet Explorer web browser manufactured by Microsoft Corp. In other embodiments, the browser is any version of the Chrome web browser manufactured by Google Inc. In other embodiments, the browser is any version of Firefox web browser distributed by the Mozilla Foundation. In further embodiments, the browser is any version of the Opera browser by Opera Software ASA.

The page 517 may include any type and form of content processable by any embodiment of the browser 515. The page may be stored on any number of servers, such as content providers 120 and may be accessed and/or loaded by any web browser, such as browser 515. The page may be a web page. The page be a document, The page may be a file. The page may any resource accessible via a network or a world wide web by a networked device, such as a client computer 130. The page may be identified by a URL. The page may include content from a URL. The page may include any type and form of executable instructions, such as scripts, AJAX. The page may include any type and form of graphics and/or text. The page may include any type and form of media, such as video or audio media. The page may include content having text, words, keywords and links or hyperlinks to other web pages or web sites.

Page 517 may include any document which may be accessed, loaded, viewed and/or edited by a browser 620 and displayed on a computer screen. Page 517 may include any content which may be presented via hypertext markup language, extensible markup language, java, JavaScript or any other language or script for preparing web pages. Web page may include any type and form of components for adding animation or interactivity to a web page, such as Adobe Flash by Adobe Systems Inc. The page may include functionality for displaying advertisements, such as advertisements from enterprises, government, companies and firms. A web page may include any number of ad spaces providing space or arrangement within web page for displaying advertisement.

The client, browser or page may include an agent 520. The agent may include any type and form of executable instructions executable by the browser and/or client. In some embodiments, the agent comprises a script, such as JavaScript or JSON (JavaScript Notation). In some embodiments, the agent may comprise any type and form of plug-in, add-on or component to or of browser 515. In some embodiments, the agent may comprise any type of application, program, service, process or task executable by the client.

The agent 520 may be included in the page 517 when transmitted by the content provider. In some embodiments, the page includes the agent in script form as part of the content of the page. In some embodiments, the page includes a URL to the script, such as URL pointing to or identifying a resource or script of the servers 110, 110′. In some embodiments, the agent is loaded by the browser. In some embodiments, the agent is executed by the browser upon retrieval and/or loading of the page 517. In some embodiments, the page includes instructions to the browser or client to obtain and load or install the agent.

The agent 520 may include any logic, function or operations to interface to or communicate with any portion of the augmentation server 110 or ad server platform 110. The agent may include any logic, function or operations to provide any of the services or functionality of in-text 510, interest ads 512 and/or related content 514. The agent may include any logic, function or operations to identify, collect and transmit content from the page to the server 110/110′. The agent may identify, collect and transmit any and/or all text in content of the page. The agent may identify, collect and transmit any and/or all text from any pages or URLs referred to by the page. The agent may transmit any embodiments of this page content 519 to the server 110, 110′.

The agent may comprise any logic, function or operations to receive keywords, campaigns and/or augmented content from the server 110, 110′. The agent may comprise any logic, function or operations to hook keywords identified in the page content. The agent may “hook” keywords by modifying the keyword in the page content to have an indicator, such as double underlined or an icon. Hooking a keyword refers to making a keyword on the page have a predetermined visual appearance to indicate that interactivity would or may occur by the user interacting with the keyword and instrumenting the page or keyword to perform the interactivity responsive to the user interaction. The indicator may provide a visual indication that the keyword in the text is linked or hyperlinked. In some embodiment, the agent may link or hyperlink the keyword. The agent may hook the keyword to include a function, script or executable instruction to take an action responsive to a mouse over, mouse click or other user interaction. The agent may hook the keyword to display a user interface overlay or tooltip such as depicted in FIG. 5J. The agent may hook the keyword to display a related advertisement or augmented content on the page as also depicted in FIG. 5J.

The keyword matcher 522 of the server 110, 110′ may comprise any type and form of executable instructions executable on a device. The keyword matcher may comprise any logic, function or operations to identify matches between one data set and another data set. In some embodiments, the keyword matcher may identify matches between keywords of campaigns with page content. In some embodiments, the keyword matcher may identify whole or complete matches. In some embodiments, the keyword matcher may identify partial or incomplete matches. In some embodiments, the keyword matcher may identify partial or incomplete matches within a predetermined threshold. In some embodiments, the keyword matcher may identify both complete and incomplete matches. The keyword matcher may perform any of the keyword operations described in connection with FIGS. 5A through 5F. The keyword matcher may be included as part of the context engine, interest engine or campaign selection engine of the ad server platform.

The keyword ranker 522 of the server 110, 110′ may comprise any type and form of executable instructions executable on a device. The keyword ranker may comprise any logic, function or operations to rank a set of data responsive to one or more criteria. The keyword ranker may comprise any logic, function or operations to rank keywords matched to page content. The keyword ranker may comprise any logic, function or operations to provide a weighting to a keyword based on any metrics of the keyword, such as location, frequency, and length. The keyword ranker may comprise any logic, function or operations to provide a weighting to a keyword based on relevancy to the site. The keyword ranker may comprise any logic, function or operations to provide a weighting to a keyword based on relevancy to a publisher or content provider. The keyword ranker may comprise any logic, function or operations to provide a weighting to a keyword based on relevancy to a campaign. The keyword ranker may comprise any logic, function or operations to provide a weighting to a keyword based on relevancy to a user or behavioral profile. The keyword ranker may be included as part of the context engine, interest engine or campaign selection engine of the ad server platform.

The keyword ranker may perform any of the keyword ranking and/or weighting operations described in connection with FIGS. 5A through 5F. An output or result of the keyword ranker may be ranked keywords 528. The ranked keywords may include any type of object, data structure or data stored in memory or to storage. The ranked keywords may include contextually targeted ranked keywords as described in connection with FIGS. 5A through 5F. The ranked keywords may include behavioral targeting ranked keywords as described in connection with FIGS. 5A through 5F. The ranked keywords may include any combination of contextually targeted ranked keywords and behavioral targeting ranked keywords. The ranked keywords may be site specific. The ranked keywords may be campaign specific. The ranked keywords may be publisher specific. The ranked keywords may be based on any combination of site, campaign and/or publisher.

The campaign selection engine 506 may interface or communicate with any of the keyword matcher, the keyword ranker and/or ranked keywords. The campaign selection engine 506 may access, read or process campaigns 526. The campaigns 526 may be stored in any type and form of database or file system. The campaigns 526 may include information identifying keywords for the campaigns and augmented content to deliver for those keywords. The campaigns 526 may include any type and form of content, URLS, scripts, video, audio, advertisements, media, text, graphics, data, information etc. to provide as augmented content with the keywords. The campaigns 526 may include any type and form of URLs, advertisements, media, text, graphics, etc. to provide as augmented content with the keywords. The campaigns may identify or provide any desired user interface overlay/tooltip or content therein. The campaigns may be organized by publisher. Each publisher may have a plurality of campaigns.

The campaign selection engine selects the campaign to deliver with the page based on analysis of the page content from the keyword matcher, keyword ranker and ranked keywords. The campaign selection engine may comprise any type and form of logic, functions or operations to identify and select one or more campaigns from a list of contender or candidate campaigns based on any criteria or algorithm. The campaign selection engine may select those campaigns that best match or correspond to the top ranked keywords. The campaign selection engine may select those campaigns that match or correspond to a predetermined number of ranked keywords. The campaign selection engine may select those campaigns that match or correspond to a predetermined set of ranked keywords. The campaign selection engine may select those campaigns that match or correspond to the ranked keywords in accordance with a priority assigned to the campaigns or publisher. The campaign selection engine may exclude or include campaigns based on the logic or criteria of any rules or filters.

Responsive to the campaign selection engine, the server 110, 110′ may transmit to the agent identification of one or more keywords to augment on the page and corresponding campaigns for those keywords (see 530). The server may transmit to the agent any script, data or information to provide or facilitate hooking of the keywords on the page and displaying the campaign responsive to user interaction with the keyword. The server may transmit to the agent the indicator, or identification of the indicator) to use for a hooked keyword. The server may transmit to the agent the type and form of user interface overlay to display when a user mouse over or mouse click occurs for the keyword. The server may transmit to the agent a reference to or identification of any of augmented content to display when a mouse over or mouse click occurs for the keyword. The server may transmit to the agent the augmented content, such as the advertisement, to display when a mouse over or mouse click occurs for the keyword.

The agent may receive the information 530 from the server and modify the page or content of the agent to perform the hooking of the keywords, to instrument the hooked keywords, and/or deliver the campaign responsive to the keyword. The agent may perform any of the agent's logic, functions or operations while the web page is being loaded. The agent may perform any of the agent's logic, functions or operations while the user views or browsers the web page. The agent may perform any of the agent's logic, functions or operations in the background to the user viewing or browsing the page.

Referring now to FIG. 5J, embodiments of augmented content delivered with a corresponding keyword is depicted. In brief overview, the page 517 may include an augmented keyword in the text of the content (e.g., see double underlined “Augmented Keyword” next to “in text of content”). When a user interacts with the augmented keywords, a user interface overlay 550, also referred to as tooltip, may be displayed. This user interface overlay may deliver or provide the campaign corresponding to the keyword. Responsive to user interaction with the keyword, the agent may display related advertisements 554′, such as via a banner ad, or augmented content 556′. The related advertisements 554′ and/or augmented content 556′ may be displayed in connection with the tooltip, without the tooltip or instead of the tooltip.

Any of the content on page 517 may include any embodiments of the advertisements and/or augmented contented provided and discussed above in connections with FIGS. 1 through 4E. The tooltip may be part of a multi-layered augmentation content or advertisement unit. The tooltip may provide any one or more URLs to access related websites.

The user interface overlay 550 referred to as a tooltip may include any type and form of web beacon 545. In some embodiments, the tooltip 550 may include a plurality of web beacons. The beacon may be used for tracking a user's usage and/or interactions with the tooltip. The beacon may identify or track a length of time of any user interaction with the tooltip and/or augments keyword or inline text. The beacon may identify a URL or tracking system to register or send communications regarding the user interaction. In some embodiments, a web beacon may be designed and constructed for a predetermined tracking system.

A web beacon may be an object that is embedded in the tooltip that is not visible to the user. Sometimes beacons are referred to as web beacons, web bugs, tracking bugs, pixel tags or clear gifs. Web beacons may be used to understand the behavior of users who frequent designated web pages. A web beacon permits a third party to track and/or collect various types of information. For instance, a web beacon may be used to determine who is reading a webpage, when the webpage is read, how long the page was viewed, the type of browser used to view the webpage, information from previously set cookies, and from what computer the webpage is accessed.

The tooltip may be incorporated, integrated or presented with any one or more of related advertisements 554, related video 558 and/or real time statistics 562. The tooltip 550 may include an URL 560 to any web page or resource, such as additional content, search results, or media. Although the tooltip 550 is illustrated each with a related advertisement, related video and related statistics, the tooltip 550 may be presented with one of these related content or a plurality of these related contents. Although this related content is illustrated in a location, size and position in relation to the tooltip, the related advertisements, related video, and/or real time statistics may be arranged, organized or presented in any manner.

The tooltip may also include one or URLs 560, such as a hypertexted URL or link to any other page or content. In some embodiments, the hypertexted link 560 comprises a URL of a landing page of a web site. In some embodiments, the hypertexted link 560 comprises a URL of a web page providing search results directly from the search engine.

In another embodiment, the hypertexted link 560 provides a link to a recommend or most relevant search result. In other embodiments, the hypertexted link 560 provides a link to run the search query on a second search engine. The hypertexted link 560 may bring the user to a landing page of the search results of the second search engine.

The related advertisements 554 may include any type and form of advertisement related to the augmented content or inline text or otherwise related to the keyword. In some embodiments, the related advertisements are advertisements provided as described in connection with any of the embodiments of the FIGS. 1A-4E. In some embodiments, the related advertisements are advertisements provided by a search engine, such as in relation to and based on the search query. In other embodiments, the related advertisements are provided by any type and form of ad network via the server 110, 110′ and/or search engine.

The related video 558 may include any type and form of video media related to the augmented content or inline text or otherwise related to the keyword. In some embodiments, the related videos are advertisements provided as augmented content as described in connection with any of the embodiments of the FIGS. 1A-4E. In some embodiments, the related videos are videos provided by a search engine, such as in relation to and based on a search query. In other embodiments, the related videos are provided by any type and form of video service, such as YouTube.com or iTunes.com. In another embodiment, the related videos are videos available to the user via a user accessible storage or video management system.

The real time statistics 562 may include any type and form of statistics related to the augmented content or inline text or otherwise related to the keyword. In some embodiments, the real time statistics 562 may be any statistics related to the person or entity of the search. For example, if the augmented keyword is a sports team, the real time statistics may include current or recent game scores and/or standings of the team. In another example, if the augmented keyword is related to the weather, the real time statistics may include a current weather forecast. In one example, if the augmented keyword is related to a musician, the real time statistics may include statistics on music downloads, album sales and top music chart location.

Referring now to FIG. 5K, embodiments of a method for augmented content of a keyword of a web page being loaded into a browser is depicted. In brief overview, at step 580, an agent of the browser to server 110, 110′ upon or while loading a web page. At step 582, the server analyzes the page data and reduced the page data set. At step 584, the server performs content filtering on page and keywords to match to corresponding campaigns. At step 586, the server performs ranking of keywords. At step 588, the server matches the ranked keywords to keywords of each campaign. At step 590, the server selects top matching keywords and their campaigns. At step 592, the server sends to the agent the selected keywords and their campaigns and may provide the agent tooltips and/or augmented content. At step 594, the agent hooks the keywords identified by the server. At step 596, the agent detects user interaction such as mouse over or clock of keywords and displays augmented content, such as a tooltip.

In further details, at step 580, the agent may be executed by the browser upon or while loading the web page. The browser may retrieve the agent via a URL identified by the page. In some embodiments, the page transmitted by the server includes the agent. The agent may comprise script places or arranged at or near the top page to be executed by the browser. In some embodiments, the agent may be triggered by any load events or APIs of the browser. The agent may be executed prior to content of the web page being loaded or displayed. The agent may be executed prior to the retrieval of any URLS of the page. The agent may be executed prior to completion of loading of the web page by the browser.

The agent may identify, gather and aggregate data from the page. The agent many identify all text portions of the web page. The agent many identify those elements of the page that contain text. The agent may identify text from a predetermined set of elements of the page. The agent may identify text from HTML, XML or other page languages. The agent may identify text from the body of an HTTP portion of the page. The agent may perform text recognition on any portion of the page or any element of the page. The agent may identify text from any URLS or other content referred to or loaded by the page. The agent may identify any other date of the page, including headers. For example, the agent may identify the browser type, the user, location, IP addresses from the content of the page or from any of the network packets used for communicating the page. In some embodiments, the agent performs analysis and identified metrics for the page date, such as text location, frequency, length and repeatability.

The agent may gather the identified page data, text or otherwise, and/or any page metrics and transmits the page data and/or page metrics to the server 110, 110′. In some embodiments, the agent transmits the page data together in one transaction with the server. In some embodiments, the agent transmits portions of page data in a series of transactions with the server. In some embodiments, the agent transmits the page data using any type and form of protocol. In some embodiments, the agent transmits the page data as a background process to the browser loading the page or the user browsing the page. In some embodiments, the agent transmits the page data while the browser is loading the page.

At step 582, the server analyzes the page data and reduces the page data to a working set of page data to continue analysis. The server may remove a predetermined set of commons words, such as a, and, the, from the page data. In some embodiments, the server may filer a predetermined set of words, phrases, terms or characters according to any filters, rules or policies. In some embodiments, the server may identify and correct any typos or other inadvertences with the page data. In some embodiments, the server may perform any type and form of metrics on the page data. In some embodiments, the server may identify location, frequency, repeatability of text on the page. In some embodiments, the server may identify location, frequency, repeatability of text on the page data relative to other text on the page.

At step 584, the server analyzes the text from the working set of page data to determine if there is any type and form of matching to any campaigns. In some embodiments, the server performs any type and form of semantic matching to match keywords on the page semantically to concepts, meanings, categories, subject matter and/or keywords of campaigns. In some embodiments, the server performs a phonetic match between keywords on the page to keywords of campaigns. In some embodiments, the server performs a spelling match between keywords on the page to keywords of campaigns. In some embodiments, the server performs content filtering on text, words, and portions of content around the keywords on the page to determine a context for the keywords and match that context to campaigns. In some embodiments, the server performs content filtering on the page data to determine a category, a sub-category, a topic, subject matter or other information indicator and matches the same to any one or more campaigns.

In some embodiments, the server may generate a set of keyword from campaigns targeted towards the site of the page or publisher of the page. The server may generate a site keyword list. The keyword matcher of the server may match keywords from a keyword list, such as the site keyword list, against text of the page data to identify keywords in the page data. In some embodiments, the keyword matcher identifies multiple word phrase matches. In some embodiments, the keyword matcher identifies partial word phrases. In some embodiments, the keyword matcher identifies a number of times or the frequency for which a keyword is found in the page data. In some embodiments, the keyword matcher identifies the location of the keyword in the page data, and in further embodiments, relative to other keywords or boundaries of the page, such as top or bottom.

At step 586, the server performs any type and form ranking of keywords of the page data identified by the keyword matcher. The keyword ranker may rank all of the matching keywords. The keyword rank may rank a predetermined number of keywords. The keyword ranker may rank the keywords according to any one or more metrics. The keyword ranker may rank the keywords according to any one or more criteria. The keyword ranker may rank each keywords by applying a weight to a value assigned to the keyword. The keyword ranker may provide any multipliers to a valued or weighted value of the keyword to increase or decrease the ranking of the keyword. The keyword ranker may rank the keywords on any type and form of scale, which may be absolute or relative.

At step 588, the server matches the ranked keywords to keywords of one or more campaigns. The keyword matcher, ranker or campaign selection engine may compare the list of ranked keywords, or any portions thereof, to a list of keywords of one or more campaigns. In some embodiments, the server identifies those campaigns that are contenders to be a selected for the campaign for this page. In some embodiments, the server identifies those campaigns associated with or assigned to be a campaign targeted to site or publisher of the page. The server may match the ranked keywords against the identified campaigns. In some embodiments, the server may match the ranked keywords against all campaigns. In some embodiments, the server may change the ranking of the keywords based on results of matching the keywords from the campaigns.

At step 590, the campaign selection engine selects a predetermined number of matching keywords and their campaigns. In some embodiments, the campaign selection engine selects a predetermined number of top matching keywords and their campaigns. In some embodiments, the campaign selection engine selects a number of top matching keywords and their campaigns corresponding to a number of matching keywords on the page. For example, if there are five unique keywords on the page and each identified by a campaign, the server may select five campaigns. In some embodiments, the campaign selection engine may select one campaign for a plurality of corresponding matching keywords on the page.

In some embodiments, the campaign selection engine may filter out campaigns based on any type and form of filter rules. The campaign selection engine may rank campaigns according to any type and form of ranking. For example, the campaign selection engine may prioritize campaigns according to clients, volume, importance, spend, budget, historical campaign performance or any other desired criteria. The campaign selection engine may compare the ranked keywords to the ranked campaigns. The campaign selection engine may select any of the higher or highest ranked campaigns matching any of the higher or highest ranked keywords.

At step 592, the server sends to the agent the selected keywords and their campaigns. Responsive to the campaign selection engine, the server may send to the agent the list of keywords to augment or hook and their corresponding campaigns. In some embodiments, the server sends a predetermined number of additional keywords to augment or hook in case the agent cannot hook or augment any one or more keywords in the list of keywords. In some embodiments, the server sends an ordered list of keywords. The ordered list of keywords may identify a priority of augmentation or hooking to the agent.

The server may send any type and form of information to the agent on how to augment or hook a keyword, what type of augmentation to use and identifying the form and content of the augmentation. In some embodiments, the server sends to the agent publisher and campaign identifiers for the agent to obtain or identify the appropriate campaign for a keyword. In some embodiments, the server sends the agent an indication of the visual indicator to use for the hooked keyword (e.g., double underlined). In some embodiments, the server sends the agent the executable instructions by which the keyword is hooked or for replacing the text of the keyword with a hooked keyword.

In some embodiments, the server sends instructions for content, construction and/or display of the tooltip. In some embodiments, the server sends a set of executable instructions providing the tooltip and/or any portion thereof. In some embodiments, the server sends a set of executable instructions providing the augmented content and/or any portion thereof. In some embodiments, the server sends a set of executable instructions providing any embodiments of the augmented content, advertisements and/or tooltip of FIG. 5I. In some embodiments, the server sends content for the tooltip to provide the campaign assigned to the keyword. In some embodiments, the server sends one or more URLs referencing a campaign to be delivered via a web-site. For example, in some embodiments, the server sends one or more URLS to advertisements to be delivered for the campaign. In some embodiments, the server sends one or more scripts to agent to provide any of the above embodiments.

At step 594, the agent hooks the identified keywords on the page The agent may replace each keyword in the identified list of keywords from the server with instructions or code to hook the keyword. The agent may have hyperlink or link the keyword to a set of code or executable instructions to display the tooltip, augmented content or any embodiments of FIG. 5J. The agent may use modify the keyword to provide any type and form of visual indicator (e.g., double underlined or icon) to indicate the keyword is user interactive, hyperlinked or linked or otherwise hooked. The agent may modify the page to change the text to a liked or hooked text and to link or associated any forms of augmented content of FIG. 5J to be displayed or provided via user interaction with the hooked text. The agent may modify the page or instrument the keyword to detect when a user interacts with the keyword in a certain way. The agent may include one or more event based functions that are trigged responsive to predetermined user interactions. For example, the agent may modify the page or instrument the keyword to detect when a user mouses over the keyword, clicks on the keyword, right clicks on the keyword or left clicks on the keyword or otherwise selects any predetermined set of keystrokes or sequence of keystrokes.

At step 596, the agent detects user interaction such as mouse over or click of a keyword on the page and displays augmented content, such as a tooltip. The agent may detect when a mouse is over the keyword at any time. The agent may detect when a user has the cursor over the keyword. The agent may detect when a user has put focus on the keyword. The agent may detect when a mouse is over the keyword for a predetermined period of time. The agent may detect when a user highlights or selects a keyword. The agent may detect when the user left or right clicks on the keyword. The agent may detect when a user double clicks the keyword. The agent may detect when a user has put focus on the keyword and hit entered. The agent may detect any set of keystrokes with respect to the keyword.

Responsive to the detection, the agent may display augmented content, for example, any of the forms depicted in FIG. 5I. In some embodiments, responsive to detecting a mouse over of the keyword, the agent displays a tooltip delivering a campaign assigned to the keyword. In some embodiments, responsive to detecting a click on the keyword, the agent displays a tooltip delivering a campaign assigned to the keyword. Responsive to detection of the predetermined user interaction, the agent may display augmented content of any form, such as related videos, in predetermined areas or space on the page. Responsive to detection of the predetermined user interaction, the agent may display advertisements of any form, in predetermined areas or space on the page.

In some embodiments, the tooltip may remain displayed until the mouse is moved off of the keyword. In some embodiments, the tooltip may remain displayed until the mouse is moved off of the keyword for a predetermined time. In some embodiments, the tooltip may remain displayed until the mouse is moved off of the keyword until the user closes or exists the tooltip. In some embodiments, if the user clicks on the keyword after the mouse over, the tooltip remains displayed until the user closers or exits the tooltip. In some embodiments, any augmented content may change as the user moves the focus or mouse over to another keyword. For example, moving the mouse to a second keyword may cause a different advertisement to appear in a banner ad or may cause a new tooltip to be displayed or content of the current displayed tooltip to change.

The agent and may perform all or any of the steps of the method of FIG. 5K in real-time upon receipt and/or loading of the page. For example, the agent and the server may be designed and constructed to perform embodiments of steps 580 through 594 within a predetermined time while the page is being loaded by the browser. In some embodiments, the agent and the server may perform embodiments of steps 580 through 594 in milliseconds, for example within in 100, 200, 300, 400, 500, 600, 700, 800 or 900 milliseconds or within 10, 20, 30, 40, 50, 60, 70, 80 or 90 milliseconds, or within 1, 2, 3, 4, 5, 6, 7, 8 or 9 milliseconds or 0.1, 0.2, 0.3, 0.4, 0.5, 0.6, 0.7, 0.8 or 0.9 milliseconds. The agent and the server may be designed and constructed to perform embodiments of steps 580 through 594 while the page is loading and before the page is completely loaded. The agent and the server may be designed and constructed to perform embodiments of steps 580 through 594 in the background while the pages is being loaded and/or the user is browsing the loaded page.

D. Extended Content Harvesting for Contextualizing

Embodiments of systems and methods of the present solution extend the scope of content harvesting to cover a wider range of page elements that are harvested for determining keywords and content to augment the keywords To improve contextualization for keyword and augment content determination, the present solution may harvest content from parts of pages that cannot be hooked by embodiments of the systems previously described herein. Some of these parts of the pages may not be hooked or hookable, either for technical reasons, such as title tags, attributes or image alt attributes) or for policy reasons, such as anchor text. The present solution may also use formatting of keyword, such as style and structure, for contextualization as well as URLs to underlying assets and identifier or attributes of corresponding text. To further improve contextualization, the present solution may also retrieve content from linked pages not currently displayed to use parts of these pages for keywords and augmented content determination.

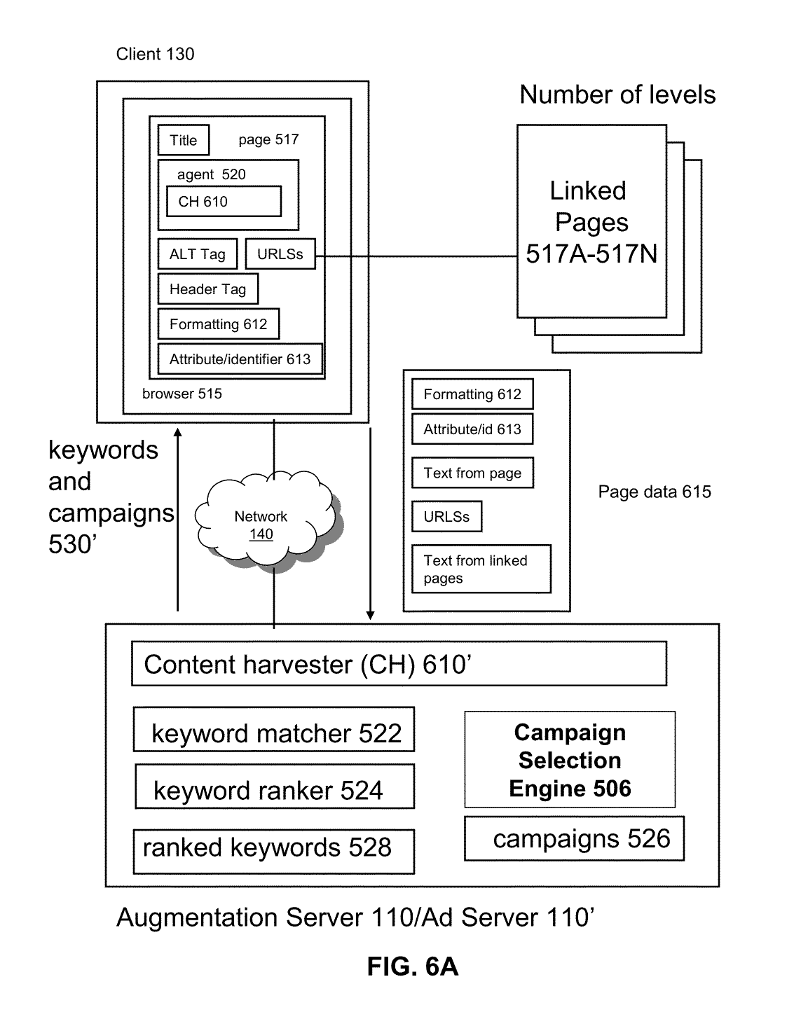

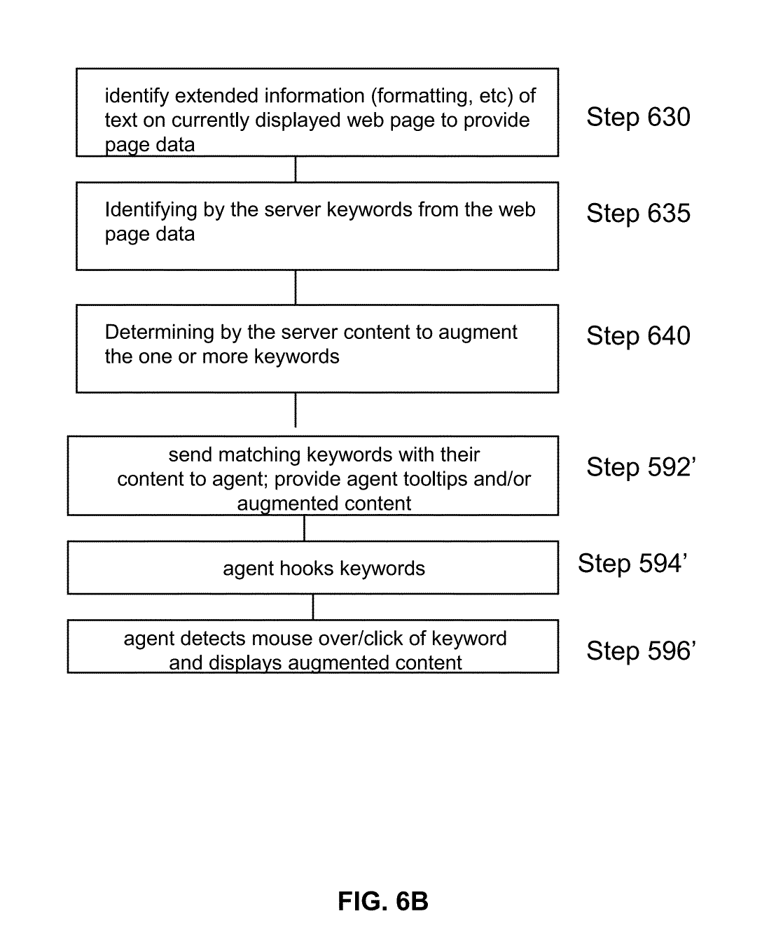

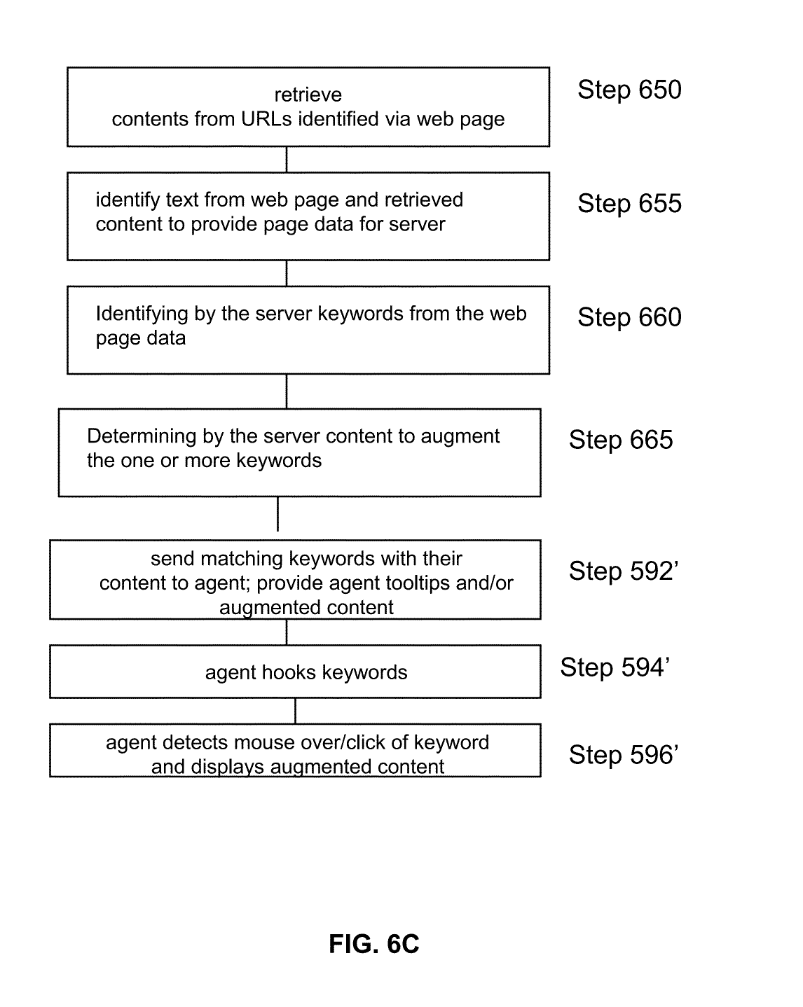

Referring now to FIG. 6A, an embodiment of a system for performing extended content harvesting is depicted. In brief overview, any of the systems previously described herein may be modified or enhanced to include a content harvester 610, 610′. The content harvester may obtain or retrieve text from unhookable parts of a page 517, such as title, ALT tag, anchor text and header tags. The content harvester may also retrieve content identified by URLs on a current page 517, such as content from linked pages 517A-517N. The agent may identify hookable text from the page 517. The agent may sent page data 615 to the server. The page data may include content or text identified from the page 517 and/or content or text from the unhookable parts of the page 517, and/or content or text identified from the linked pages 517A-517N. In the process of keyword matching, ranking and campaign selection, the server may use content from the page data to determine keywords from the page date and content for which to augment such keywords.

The content harvester 610 may be any type and form of executable instruction executing on a device. The content harvester may be a part of the agent. In some embodiments, the content harvester comprises instructions in the form of script, such as Javascript, executed as part of the agent. In some embodiments, the content harvester is a separate set of executable instructions, such as a script, that executes on the client. The content harvester may execute as part of the browser or in the memory space of the browser. In some embodiments, the content harvester may execute on the server, such as content harvester 610′. In some embodiments, a portion of the content harvester 610 may execute on the client and another portion of the content harvester 610′ may execute on the server. In some embodiments, the content harvester 610 of the client sends page or content thereof to the content harvester 610′ to perform identification and retrieval of text.

The content harvester 610 may be designed and constructed to identify, obtain or retrieve content from a page 517 or portions thereof. The content harvester may identify and retrieve content for a web page being loaded or being displayed. The content harvester may identify and retrieve content from a predetermined portion of a page. The content harvester may identify and retrieve text areas from a page. The content harvester may identify and retrieve hookable text areas from a page. In some embodiments, the content harvester may identify and retrieve content from user selected or defined portions of the page. In some embodiments, the content harvester may identify keywords in the page.

The content harvester may identify one or more URLs on a web page. The content harvester may identify any URLs on the currently displayed web page. In some embodiment. In some embodiments, the content harvester may identify URLs from predetermined portions of the page. In some embodiments, the content harvester may identify URLs from user selected or defined portions of a page. In some embodiments, the content harvester may identify a predetermined number of URLs. The content harvester may retrieve content from the identified one or more URLs. As with any of the embodiments of the content harvester above for a page being loaded or displayed, the content harvester may retrieve content from the identified one or more URLs and identify and retrieve any text or other portions of the retrieved content. The content harvester may identify and retrieve any hookable or non-hookable text portions of the retrieved content, including title, ALT tag, anchor text and header tags.

The content harvester may identify any formatting 612 of text portions of content, of current page or retrieved content. In some embodiments, the content harvester identifies any stylistic information of text, including but not limited to font, size, color, font style, font or text effect, an underline style and/or color. In some embodiments, content harvester identifies or determines a text is bolded. In some embodiments, the content harvester identifies any structural information of text, including but not limited to whether the text is in, part of or associated with a table, a paragraph, a predetermined numbered paragraph, an outline, a script, a tag or attribute. In some embodiments, the content harvester identifies any structural information of text in terms of elements or structure of a corresponding Cascading Style sheet (CSS). In some embodiments, the content harvester identifies any structural information of text in terms of elements or structure of an HTML/DHTML page. In some embodiments, the content harvester identifies any identification information 613 of text, including but not limited to, a class name, a CSS class name, a property, CSS property, name, id, or attribute.

The content harvester may perform multi-level content harvesting up to a predetermined depth level or within a predetermined time period. For the current web page, the content harvester may identify via URLs any linked pages 517A-517N. The content harvester may retrieve the content from these linked pages. The content harvester may identify URLs in the content retrieved from these linked pages to identify and retrieve content from a second layer of linked pages. The content harvester may keep identifying URLs in pages linked to a predetermined depth (e.g. 2^{nd} layer, 3^{rd} layer, 4^{th} layer . . . Nth layer of linked pages). The content harvester may keep identifying URLs in n-depth layers up until a predetermined time period (e.g., keep traversing to Nth layer until a timer expires).

In further details, the page 517, such as a web page being currently loaded or being displayed on the client via the browser may have various different parts that can be harvested by the content harvester 610. In some embodiments, the page may comprise a page title. The page title may be the TITLE element in the HEAD section of an HTML document. The title element may identify the contents of the document. The page title or title element may be designed or constructed to be search engine friendly. The page title may include one or more primary keyword phrases. The page title may include one or more secondary keywords phrases. The page title may include a combination of one or more primary keywords and one or more secondary keywords.

The page may include one or more header tags. Header tags may be used to define HTML headings. Header tags may identify the relevant importance of the section. The <h1> may define the most important heading while <h6> may define the least important heading. The author of the page may put information about the subject matter of the page in the header tags.

The page may include anchor text. The anchor text may include the textual components of hyperlinks (text links). Anchor text may provide additional descriptive information about the referred page and, therefore, may be used as metadata. The anchor text sometimes referred to as a link label or link title is the visible, clickable text in a hyperlink. In some embodiments, for policy reasons an anchor text may be determined not to be hookable by the systems and methods described herein although is the type of page element that can be hooked by the systems and described herein. So, although not to be hooked by the system, the anchor text may remain useful for contextualization and campaign selection described herein.

The page may include one or more ALT attributes, which may sometimes be referred to as ALT tags. The alt attribute may be used in HTML type documents to specify alternative text (alt text) that is to be rendered when the element to which it is applied cannot be rendered. The ALT attributed may be an attribute of an image tag. In some embodiments, the browser displays the ALT attribute text in a tooltip. Where the page has an image, the editor or author may put useful information about the subject matter in the ALT attribute.

In some embodiments, the agent, such as via content harvester 610 identifies the page title, anchor text, header text and/or ALT attributes for the page 517. The page title, header text and/or ALT attributes may be parts of the page that are not hookable to provide augments content such as by the embodiments of methods described in conjunction with FIG. 5K. The agent may identify any text from any of these parts of the page. The agent may use or combine the text from the page title, header text and/or ALT attributes in combination with any text in the body of the page 517.

In some embodiments, the agent, such as via content harvester 610 identifies the URLs or hyperlinks in the page 517. The agent may retrieve content from the page or resource identified by a URL or hyperlink. In some embodiments, the agent retrieves all the content from the URL. In some embodiments, the agent retrieves all the content from the URL except for images. In some embodiments, the agent retrieves predetermined type of content from the URL, such as text, page title, anchor text, header text and/or ALT attributes. In some embodiments, the agent retrieves text from the content of the URL. In some embodiments, the agent sends the URLs or the page with the URLs to the server, such as content harvester 610′, to retrieve content and identify text from the retrieved content of the URLs. In some embodiments, the agent identifies, retrieves and processes content from the URLs of a page as the page is being loaded or being displayed. In some embodiments, the agent identifies, retrieves and processes content from URLs that are not being currently loaded or displayed on a page that is being loaded or displayed.

The agent may send page data 615 to the server. The page data may comprise any portion of the currently being displayed and/or any portion of content retrieved from the URLs not currently being displayed. The page data may include text from the page being loaded or currently displayed. The page data may include retrieved content or text from any URLs of the page being loaded or currently displayed. The page data may include a first set of text selected by the agent from the page currently being loaded or displayed and a second set of text selected and retrieved by the agent from URLs identified on the page currently being loaded or displayed. The page data may include one or more URLS corresponding to or identifying one or more assets, such as a script or image. The page data may include formatting of any text, whether or not the text is included in the page data. The page may include any attribute or identification information 613 of any text, whether or not the text is included in the page data. In some embodiments, the page data includes any stylistic, structural and/or identification information corresponding to text in the page data.

Referring now to FIG. 6B, an embodiment of a method for content harvesting is depicted. In brief overview, at step 630, content is harvested from extended information of text, such as formatting and identification information, on a page being loaded or displayed. At step 635, server receives page data including the extended content information. At step 640, the server identifies keywords from the page data. At step 665, the server determines content to augment the identified keywords. At step 592′, the server sends to the agent the selected keywords and their content and may provide the agent tooltips and/or augmented content. At step 594′, the agent hooks the keywords identified by the server. At step 596′, the agent detects user interaction such as mouse over or clock of keywords and displays augmented content, such as a tooltip.

In further details of step 630, the agent via content harvester may identify any extended content or context information of text on a page, such as page being loaded or displayed. The extend content or context information may including formatting and/or identification information of text. In some embodiments, the agent identifies any formatting information 612 of any text, hookable or not. This may include identifying any stylistic or structural information of the text. In some embodiments, the agent identifies any identification information 613 of any text, hookable or not. The agent may identify any URLs for any underlying assets of the page. The agent may identify a URL to an image on the page. The agent may identify a URL to a script on the page.

The agent generates, forms or otherwise provides page data for processing by the augmentation server. The agent may provide page data comprising text identified from the current page. The agent may identify any non-hookable text of a page title, header tag or ALT attribute from the current page. The page data may include formatting information of text in the page date, such as stylistic and/or structural information of text. The page data may include identification information of text in the page date, such as a name, identifier or attribute of the text. The page may data may include one or more URLs to a script and/or image.

In some embodiments, the agent filters any of the text from the current page in providing such page data to the server. In some embodiments, the agent reduces duplicate text. In some embodiments, the agent reduces text of the same verb having different tenses or participles, such as to a base form of the verb. In some embodiments, the agent reduces text with different plurals of the same noun to a base form of the noun. In some embodiments, the agent filters the text based on frequency of the text in the content of the current page and/or content of the retrieved content. In some embodiments, the agent filters the text based on location of the text in the content of the current page and/or content of the retrieved content.

The agent transmits or communicates the page data to the server. The agent may transmit the page data in one transmission. In some embodiments, the agent transmits the text of the current page in one or more transmissions. In some embodiments, the agent transmits the extended content information in one or more transmissions. In some embodiments, the agent transmits the extended content information with the text. In some embodiments, the agent transmits the extended content information separate from the text. In some embodiments, the agent transmits the URLs with the extended content information. In some embodiments, the agent transmits the URLs with the text.

At step 635, the server identifies keywords from the page data. The server may use unhookable text portions in the page data to identify keywords. The server may use any text (hookable or unhookable) to identify keywords. The server may use any extended content information, such as formatting and/or identification information to identify keywords. This step may include any of the steps of and embodiments of the steps 582, 584, 586, and/or 588 described in connection with FIG. 5K. In the context of step 635, these steps may be performed with page data that includes unhookable text, such as page title, anchor text, header attributes and ALT attributed. In the context of step 635, these steps may be performed with page data that includes formatting and/or identification information of text, such as stylistic and structural information. In the context of step 635, these steps may be performed with page data that includes URLs to one or more assets, such as scripts and/or images.

In some embodiments, the extended content information may be weighted or used to perform weighting for keyword selection. In some embodiments, the unhookable text may be weighted or used to perform weighting for keyword selection In some embodiments, the formatting and/or identification information of text may be weighted or used to perform weighting for keyword selection. In some embodiments, the stylistic information may influence the weight, ranking or relevancy for a keyword. For example, if the keyword is bolded, the weighting, ranking or relevancy of a keyword may be changed. In some embodiments, the structural information may influence the weight, ranking or relevancy for a keyword. For example, if the keyword is part of a script or in a certain paragraph, the weighting, ranking or relevancy of a keyword may be changed. In some embodiments, the identification information may influence the weight, ranking or relevancy for a keyword. For example, if the text is identified by a predetermined name, attribute or property, the weighting, ranking or relevancy of a keyword may be changed. The server may analyze and use any of the formatting and/or identification information an manner to impact or influence weight, ranking or relevancy of a keyword.

At step 640, the server determines content to augment the identified keywords. This step may include any of the embodiments of step 590 described in connection with FIG. 5K. In the content of embodiments of this method, as the keywords are identified using page data that may include unhookable text, the determination of augmentation content may be influenced or impacted by the same. In some embodiments, the unhookable text may increase the relevancy of weighting of certain keywords to change how they are used or how they match campaigns during campaign or augmented content selection. In the content of embodiments of this method, as the keywords are identified using page data that may include formatting and/or identification information, the determination of augmentation content may be influenced or impacted by the same. In the content of embodiments of this method, as the keywords are identified using page data that may include URLs, the determination of augmentation content may be influenced or impacted by the same

The server may identify or determine a relevant advertisement campaign based on the one or more keywords. The server may identify or determine page views from content of a published or web site to provide as augmented content based on the one or more keywords. In some embodiments, the unhookable text content is used for contextualizing a page to determine the context of the page. In some embodiments, the formatting information of text is used for contextualizing a page to determine the context of the page. In some embodiments, the identification information of text is used for contextualizing a page to determine the context of the page. The server may use any combination of extended content information and keyword to determine a context of the page. Based on the context, the server may identify or determine campaigns or augmented content for delivering to the client for the current page.

Based on the unhookable text and/or extended content information, the server may filter out certain campaigns or augmented content during the selection process. Based on the formatting of text, the server may filter out certain campaigns or augmented content during the selection process. Based on the identification information of text, the server may filter out certain campaigns or augmented content during the selection process. With a deeper reach of information within the page the page, the server may determine a better matching campaign or more appropriate augmented content.

At step 592′, 594′ and 596′, the method may include any embodiments of these steps described in connection with FIG. 5K. At step 592′, the server may communicate campaigns selected by the server based on the identified keywords from the page data including unhookable text. In some embodiments, at step 592′, the server may communicate campaigns selected by the server based on the formatting of keywords from the page data. In some embodiments, at step 592′, the server may communicate campaigns selected by the server based on the identification information of keywords from the page data. At step 594′, the client agent hooks the identified keywords on the currently displayed web page or the web page being currently loaded. At step 596′, the augmented content is displayed as an overlay or tooltip on the current page responsive to detecting a mouse-over. Based on the systems and methods described herein, the augmented content delivered to the client and displayed to the user are based on unhookable text and/or extended harvesting of content from the current page.

Referring now to FIG. 6C, another embodiment of a method for content harvesting using retrieved content from one or more URLs is depicted. In brief overview, at step 650, content is harvested from one or more URLs identified on a page being loaded or displayed. At step 655, text from the page being loaded or displayed and text from the content retrieved via the URLs is identified. Page data is sent to the server. At step 660, the server identifies keywords from the page data. At step 665, the server determines content to augment the identified keywords At step 592′, the server sends to the agent the selected keywords and their content and may provide the agent tooltips and/or augmented content. At step 594′, the agent hooks the keywords identified by the server. At step 596′, the agent detects user interaction such as mouse over or clock of keywords and displays augmented content, such as a tooltip.

In further details of step 650, the agent via content harvester 610 may identify one or more URLs on a page being loaded or displayed by a browser of a client. In some embodiments, the agent may identify any URLs in the body of the page. In some embodiments, the agent may identify any URLs in the text area of the page. In some embodiments, the agent may identify any URLs having one or more predetermined strings or keywords. In some embodiments, the agent may identify any URLs from a web-site, domain, publisher or content provider. In some embodiments, the agent may identify a predetermined number of URLs from the page being loaded or displayed on the client. In some embodiments, the agent may identify any URLS of the page that are not currently being displayed or loaded on the page. In some embodiments, the agent may identify portions of the content from the page being loaded or displayed, such as text areas or unhookable areas such as page title, header tags, anchor text and ALT attributes. In some embodiments, the agent may identify any formatting of text on the current page. In some embodiments, the agent may identify any identification information of text on the current page

The agent via content harvester may retrieve content from any of the identified URLs. In some embodiments, the agent may retrieve content from as many of the identified URLs that may be retrieved within a predetermined time period. In some embodiments, the agent may perform multi-level harvesting by identifying and retrieving content from URLs identified and retried from the current web page. In some embodiments, the agent may retrieve portions of the content from the URL, such as text areas or unhookable areas such as page title, header tags, anchor text and ALT attributes. In some embodiments, the agent may search the content of the URL to determine if any text matches, corresponds to or is otherwise related to any terms, keywords or text of the current page. In some embodiments, the agent may retrieve the page from the URL and perform the same processing on the retrieved page as the page being loaded or displayed. In some embodiments, the agent may identify any formatting of text of retrieved content or pages. In some embodiments, the agent may identify any identification information of text of retrieved content or pages.

At step 655, the agent generates, forms or otherwise provides page data for processing by the augmentation server. The agent may provide page data comprising text identified from the current page. The agent may identify any non-hookable text of a page title, header tag or ALT attribute from the current page. The agent may provide page data comprising text from content retrieved from any one or more URLs of the current page data. The agent may identify any non-hookable text of a page title, anchor text, header tag or ALT attribute from the content retrieved via the URLs. The agent may provide page data comprising any combination of text from the current page and text retrieved via URLs. The agent may identify in the page data that a first set of text is from within the current page and a second set of text is from the retrieved content of the URLs. In some embodiments, the agent combines the text from both sources to a single set of text comprising text from the current page and text from the URLs. The agent may provide page data comprising any formatting of corresponding text in the first set of text and/or the second set of text. The agent may provide page data comprising any formatting of any text in the page that is not included in the page data. The agent may provide page data comprising any identification information of corresponding text in the first set of text and/or the second set of text. The agent may provide page data comprising any identification information of any text in the page that is not included in the page data. The agent may provide page data comprising one or more URLS corresponding to a script or image, sometimes referred to as an asset.

In some embodiments, the agent filters any of the text from the current page and/or from the URLs in providing such page data to the server. In some embodiments, the agent reduces duplicate text. In some embodiments, the agent reduces text of the same verb having different tenses or participles, such as to a base form of the verb. In some embodiments, the agent reduces text with different plurals of the same noun to a base form of the noun. In some embodiments, the agent filters the text based on frequency of the text in the content of the current page and/or content of the retrieved content. In some embodiments, the agent filters the text based on location of the text in the content of the current page and/or content of the retrieved content.

The agent transmits the page data to the server. The agent may transmit the page data in one transmission. In some embodiments, the agent transmits the text of the current page in one or more transmissions. In some embodiments, the agent transmits the text from the retrieved content in one or more transmissions. In some embodiments, the agent transmits the text on a per URL basis. In some embodiments, the agent transmits the URLs to the server. The server may retrieve the content from the URLs.

At step 660, the server identifies keywords from the page data. The server may use unhookable text portions in the page data to identify keywords. The server may use any text (hookable or unhookable) from fetched URLs to identify keywords. This step may include any of the steps of and embodiments of the steps 582, 584, 586, and/or 588 described in connection with FIG. 5K. In the context of step 660, these steps may be performed with page data that includes unhookable text, such as page title, anchor text, header attributes and ALT attributed. In the context of step 660, these steps may be performed with page data that includes formatting and/or identification information of text, such as stylistic and structural information. In the context of step 660, these steps may be performed with page data that includes URLs to one or more assets, such as scripts and/or images. In the context of step 660, these steps may also be performed with page data fetched from URLS identified via the current web page but not displayed on the current web page. In the context of the step 660, these steps may also be performed with a combination of page data fetched from URLS identified via the current web page but not displayed on the current web page and unhookable text from the current page and/or fetched content.

In some embodiments, the unhookable text and fetched URL content may be weighted or used to perform weighting for keyword selection. Keywords founds in unhookable text and/or fetched URL content may up weight or down weight a relevancy of a keyword. For example, if keywords are found in both the hookable text of the page and the unhookable text of the page, the weighting, ranking or relevancy of a keyword may be changed. If keywords are found in both the hookable text of the page and the unhookable text of fetched URL content, the weighting, ranking or relevancy of a keyword may be changed. If keywords are found in both the hookable text of the fetched URL content and the unhookable text of fetched URL content, the weighting, ranking or relevancy of a keyword may be changed. If keywords are found in the hookable text of the page, the hookable text of the fetched URL content and the unhookable text of fetched URL content, the weighting, ranking or relevancy of a keyword may be changed. If keywords are found in the hookable text of the page but not in either the unhookable text of the page or the fetched URL content, the weighting, ranking or relevancy of a keyword may be changed.

In some embodiments, the formatting and/or identification information of text may be weighted or used to perform weighting for keyword selection. In some embodiments, the stylistic information may influence the weight, ranking or relevancy for a keyword. For example, if the keyword is bolded, the weighting, ranking or relevancy of a keyword may be changed. In some embodiments, the structural information may influence the weight, ranking or relevancy for a keyword. For example, if the keyword is part of a script or in a certain paragraph, the weighting, ranking or relevancy of a keyword may be changed. In some embodiments, the identification information may influence the weight, ranking or relevancy for a keyword. For example, if the text is identified by a predetermined name, attribute or property, the weighting, ranking or relevancy of a keyword may be changed. The server may analyze and use any of the formatting and/or identification information an manner to impact or influence weight, ranking or relevancy of a keyword.

At step 665, the server determines content to augment the identified keywords. This step may include any of the embodiments of step 590 described in connection with FIG. 5K. In the content of embodiments of this method, as the keywords are identified using page data that may include unhookable text and fetched URL content, the determination of augmentation content may be influenced or impacted by the same. In some embodiments, the unhookable text and fetched URL content may increase the relevancy of weighting of certain keywords to change how they are used or how they match campaigns during campaign or augmented content selection. In the content of embodiments of this method, as the keywords are identified using page data that may include formatting and/or identification information, the determination of augmentation content may be influenced or impacted by the same. In the content of embodiments of this method, as the keywords are identified using page data that may include URLs, the determination of augmentation content may be influenced or impacted by the same

The server may identify or determine a relevant advertisement campaign based on the one or more keywords. The server may identify or determine page views from content of a published or web site to provide as augmented content based on the one or more keywords. In some embodiments, the unhookable text and/or fetched URL content is used for contextualizing a page to determine the context of the page. In some embodiments, the formatting information of text is used for contextualizing a page to determine the context of the page. In some embodiments, the identification information of text is used for contextualizing a page to determine the context of the page. The server may use any combination of text or keywords to determine a context of the page. Based on the context, the server may identify or determine campaigns or augmented content for delivering to the client for the current page.

Based on the unhookable text and/or fetched URL content, the server may filter out certain campaigns or augmented content during the selection process. Based on the formatting of text, the server may filter out certain campaigns or augmented content during the selection process. Based on the identification information of text, the server may filter out certain campaigns or augmented content during the selection process. With a deeper reach of information within the page and linked via the page, the server may determine a better matching campaign or more appropriate augmented content.

At step 592′, 594′ and 596′, the method may include any embodiments of these steps described in connection with FIG. 5K. At step 592′, the server may communicate campaigns selected by the server based on the identified keywords from the page data including unhookable text and/or fetched URL content. In some embodiments, at step 592′, the server may communicate campaigns selected by the server based on the formatting of keywords from the page data. In some embodiments, at step 592′, the server may communicate campaigns selected by the server based on the identification information of keywords from the page data. At step 594′, the client agent hooks the identified keywords on the currently displayed web page or the web page being currently loaded. At step 596′, the augmented content is displayed as an overlay or tooltip on the current page responsive to detecting a mouse-over. Based on the systems and methods described herein, the augmented content delivered to the client and displayed to the user are based on extended harvesting of content from the current page and/or linked pages.

E. Invisible Area Detection and Contextualization

Embodiments of systems and methods of the present solution are directed to detection of invisible areas in a multi-page dynamic web page and techniques for contextualizing this type of content responsive to the dynamic nature of changing pages. For example, on certain web sites some of the content present on the page is not visible to the end user when the page first renders. To access this content, the end-user has to click on a link on the page. When the end-user clicks to a new page which was invisible, the content the end-user has been reading is replaced by content of the new page which now is visible. The switching between pages in such dynamic web pages may be done using programming techniques, such as JavaScript and dynamic HTML programming techniques. As the switching between visible and invisible pages is done programmatically, an augmentation system may be challenged in choosing the most appropriate keywords to augment from the context of the content of the multiple pages.

Embodiments of the augmentation system discussed herein improve on contextualization and keyword augmentation in the context of multi-page dynamic web pages that programmatically switch between invisible and visible areas of displayed content. Where a page has dynamic content that isn't visible to the end-user when the page is first rendered, a client agent of the augmentation system detects the visibility status of areas that may become visible after end-user action. The client agent adds event handlers so that upon these areas becoming visible the client agent sends the content data of the invisible areas, now visible, to the server and receive a new set of keywords and campaigns to place in the newly visible content.

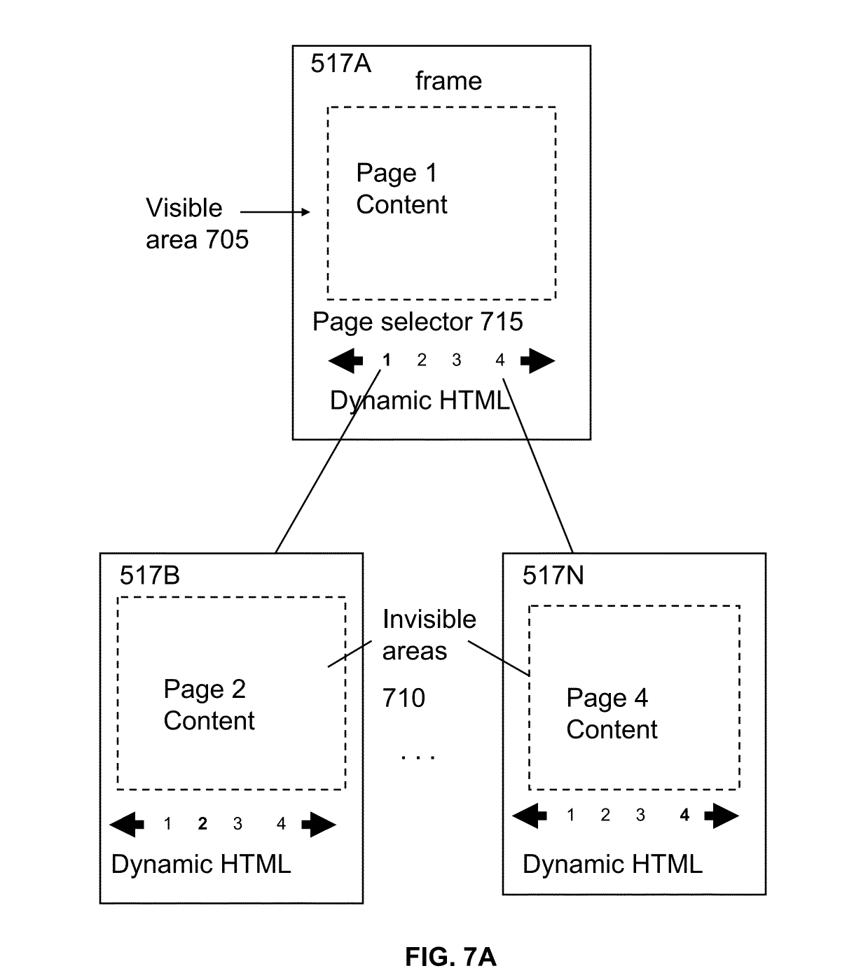

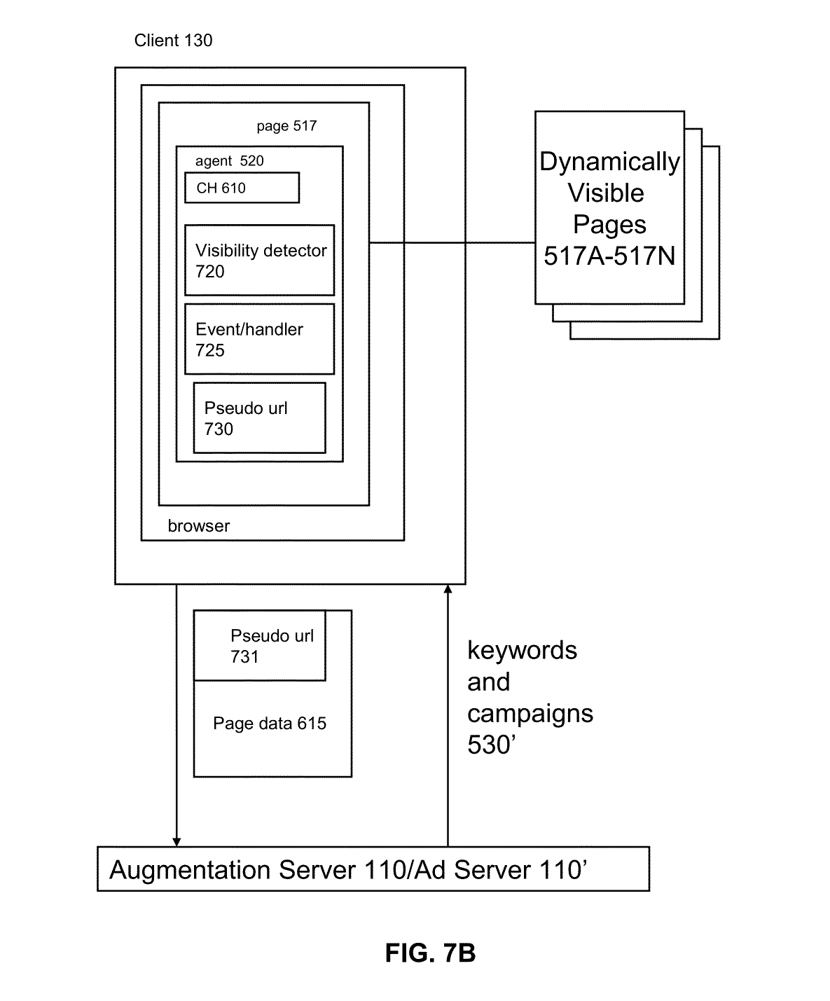

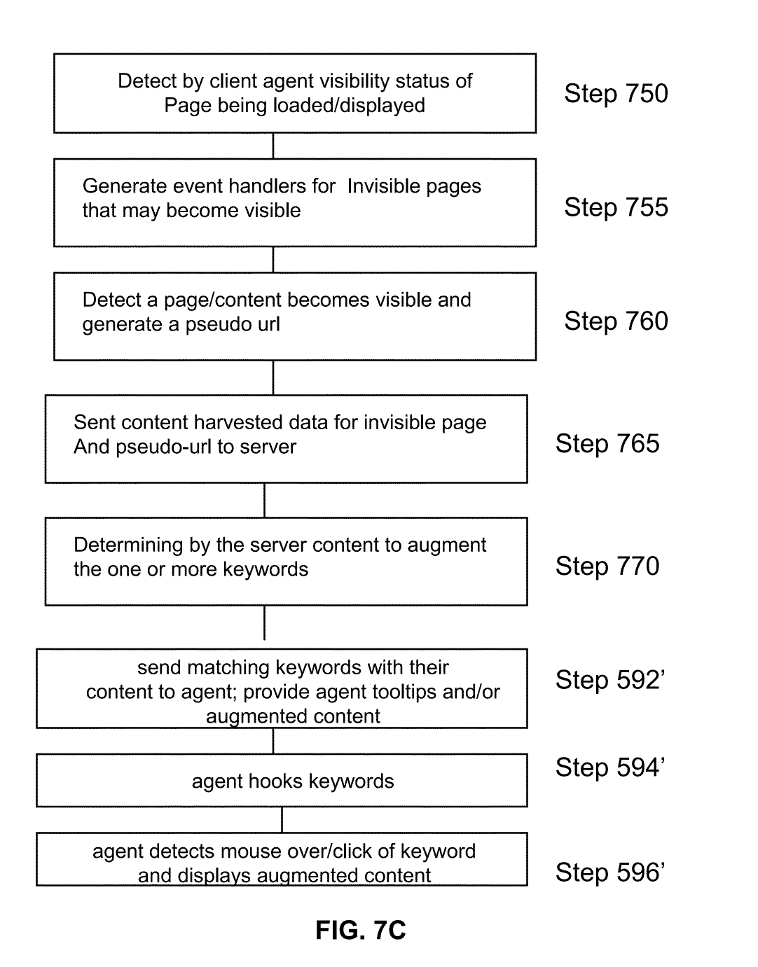

Referring now to FIG. 7A, an embodiment of dynamic content having visible and invisible areas is depicted. In brief overview, a first page 517A may initially display visible area 705 comprising page 1 content. The first page 517A may comprise dynamic content that programmatically switches to other pages 517B-517N through a page selector 715. The pages 517B-517N may include invisible areas 710. Upon selection of a second page via the page selector 517, the page 517A programmatically switches to display the content of page 2. The page 2 content becomes a visible area 705 while page 1 content becomes an invisible area. The page selector may comprising programming techniques for switching between page contents per user selection. As such, the content of each page may switch from visible (shown) to invisible (hidden) or invisible (hidden) to visible (shown).

In further details, any embodiments of pages 517A-517N may include any embodiments or portions thereof of page 517 described above in connection with FIG. 5I, 5J or 6A. The web page may comprise any scripting and/or programming code or instructions such as JavaScript and/or dynamic HTML. A single web page 517 may include a plurality of pages and content of each of the pages. The page may comprise a frame of content that surrounds the specific page content that is currently visible. The frame of content may include any type and form of user interface elements, advertisements, media, etc. that remains in view to the user on the web page as the user dynamically switches between pages. The page 517 may comprise one visible page area 705 that displays the content of the currently selected page. The page may comprise multiple visible page areas. The page may comprise one page selector. The page may comprise a plurality of page selectors.

The page may be programmed to dynamically switch content into the visible area via the page selector. For example, instead of the page selector being a simple URL link traversal, the page selector programmatically switches in content from other pages. The page selector may comprise any type and form of executable instructions, such as Javascript or Dynamic HTML, to replace content currently in the visible area with content that is currently invisible/hidden on the same page or a different page. The page selector may cause new page content to fit into the visible area 705 surrounded by the frame and to make the previously visible page content invisible.

The pages 517A-517N may be transmitted or provided as one page with content for each page contained therein. The page selector switches between the different content within the page making content corresponding to a page of the page selector visible while making content of another page corresponding a second page of the page selector invisible. In some embodiments, the page 517A-517N may be a plurality of pages 517. The page selector switches between content of one page content corresponding to a page of the page selector visible while making another page corresponding a second page of the page selector invisible.

Referring now to FIG. 7B, an embodiment of a system for invisible area detection and contextualization is depicted. In brief overview, a client 120 may include a browser and a client agent 520. The browser may load and display web pages, such as any embodiments of the dynamically visible pages 517A-517N. The client agent may include a content harvester 610, a visibility detector 720, an event handler 725 and pseudo url generator/manager 730. The visibility detector may detect which content or pages of the dynamic pages is visible and not visible. If content, such as a node of the page, is detected to be invisible, the content harvester harvests contents but may identified the content as unhookable in the page data sent to the augmentation server. For the content detected to be invisible, the client agent attaches an event handler function to the content that is executed when the event of the content becoming visible fires. When the handler is fired, the agent checks to see if the content is visible. If the content has become visible, then the client agent re-examines the harvested content and removes the unhookable flag and marks the content that has become invisible as unhookable. The pseudo-url generator generates a pseudo-url 731 based on the page url and an identifier of the invisible content that has now become visible. The client agent sends the modified harvested content as page 615 to the augmentation server 110 under the pseudo-url. The server responsive to the page data sends campaign and keyword 530 to hook to the client agent for the pseudo-url. The client agent processes the keywords and campaigns for the pseudo-url and maps the keywords and campaigns to the dynamic content that has now become visible.

In further detail, the visibility detector may comprise any type and form of executable instructions that execute as part of the client agent, browser or on the client device 130. The visibility detector may detect those portions of the dynamically visible pages 517A-517N that are visible and/or invisible. The visibility detector may also be referred to as an invisibility detector. The web pages 517A-517N may be represented by a list of nodes, such as nodes of a document object model (DOM). For example, the client agent may receive the web pages with a list of nodes. In some embodiments, the client agent may parse or process the web pages to make a node representation of the web pages and/or the content of the web pages. In some embodiments, the browser may generate or provide a programmatic model of the web page, such as DOM model. The model may comprises nodes and elements corresponding to portions of content of the web page. The browser may provide an API to access, use and/or manipulate the model, such as by a client agent.

The visibility detector may identify in the web page nodes corresponding to or matching a predetermined set or list of nodes for which hidden or invisible content may be found. Nodes in the list may be identified by any combination of tag, DOM id or CSS class name. Nodes in the list may be identified by any name or search term, including wild cards. Nodes in the list may be identified by titles or names of pages.

The list of nodes corresponding to dynamic content that may be dynamically visible (shown) and/or invisible (hidden) may be specified on a site by site basis. For example, in one embodiment, the node list may comprise an entry “*PageContent*, which corresponds to any element with an identifier, such as a DOM id, containing the string “PageContent”. Any string or other values may be used to find elements in the content or page that may contain dynamically visible/invisible content. In some embodiments, if a suitable set of node identifiers may not be determined for visibility detection then the node list may comprise and entry of “*” (single wild card) to have all nodes being checked for visible/invisible content.

The visibility detector may identify and check values of any properties corresponding to the identified nodes or content to determine whether that node or content is visible. A style sheet markup language, such as CSS, may have a visibility property that identified whether the corresponding element is visible or not. The visibility detector may use any properties of elements in the pages 517A-517N that identify whether a corresponding element is visible or hidden. If the visibility detector determines that a node is currently invisible, the visibility detector may skip or not check whether any child node is invisible.

The content harvester (CH) 610 may include any embodiments of the content harvester previously described herein. The client agent via content harvester may harvest content of any or all of the nodes. The client agent via content harvester may harvest content of nodes identifies as visible. The content harvester may harvest content for one or more nodes identified as invisible. The content harvester may harvest a set of content for each of the nodes identifies as invisible.

For content (e.g. page data 615) harvested for an invisible node, the client agent marks the node or the content to identify that the content should not be keyword augments. The client agent may mark the node or the content to identify the node as unhookable. The content harvester may mark the node or content as unhookable. The client agent or content harvester may mark content for or in the page data as either hookable and/or unhookable.

The client agent may send page 615 include content harvested from the pages 517A-517N. The page data may include content harvested from invisible and visible content. The page data may include content harvested from visible content. The page data may include content harvested from invisible content. Upon loading and/or displaying of the web page, the client agent may send page data 615 including content harvested from visible and/or invisible content. In some embodiments, the client agent sends to the server 110 a set of page data 615 corresponding to content detected as visible. In some embodiments, the client agent sends top the server 110 a set of page data 615 corresponding to content detected as invisible. The client agent may send to the server page data responsive to changes of visibility and/or invisibility of content in the dynamically visible pages 517A-517N.

Responsive to the visibility detector, the client agent generates, provides and/or attaches a handler function 725 to one or more nodes, such as those nodes detected as invisible (hidden). The handler function 725 may comprise any type and form of executable instructions for receiving and/or processing an event, such as a change to the property of an element corresponding to a node. The handler function may be executed responsive to a property change for a node, such as a visibility property indicating that a node has become visible. For cross browser support and if W3C DOM Mutation Events are supported by the browser, the client agent may use a handler comprising the on DOMAttrModified event. For versions of the browser that may not support DOM Mutation Events, the client may use a on PropertyChange event as the handler or a custom on PropertyChange event. For other situations or type of browsers, the client agent may use a custom script to check the status, such as via a Javascript time.

When the handler is executed, such as responsive to a triggering event, the handler may comprise logic, functions or instructions to check if the corresponding node is visible. In some embodiments, the handler is executed or triggered responsive to a change to a property corresponding to a node. In some embodiments, the handler is executed or triggered responsive to a change to the visibility property corresponding to a node. If the handler detects or determines that an invisible node has now become visible, the handler may trigger, direct or instruct the client agent or content harvester to harvest or re-harvest content corresponding to the now visible node.

Responsive to the handler, the client agent, such as via content harvester may re-examine the harvested content initially harvested upon loading and/or displaying the web page and/or for the initial visible content. The content harvester may content harvest the visible content again. The content harvester may identify the node and/or content as visible in the harvested content, such as in the page data 615.

The client agent via pseudo-url generator 730 may generate, create, establish or otherwise provide a pseudo-url 731 to identify the visible content or otherwise corresponding to the visible content or node. In some embodiments, the pseudo-url generator generates a url unique to the now visible content or node. In some embodiments, the pseudo-url generator generates a URL based on the URL of the page. In some embodiments, the pseudo-url generator generates a url based on a name or title of the page. In some embodiments, the pseudo-url generator generates a url based on an identifier of a node or element corresponding to the now visible content. In some embodiments, the pseudo-url generator generates a URL based on a URL of the page and an identifier of the node or element.

The client agent sends the modified page data and pseudo-url to the augmentation server. The server is unaware that the page data may belong to a page that was previously contextualized, such as from the initial harvesting of the pages. Because the server receives a pseudo-url that the server considers a new URL, the server processes the page data to determine keywords for hooking and corresponding campaigns, such as advertisements. The server sends the client agent a new set of keywords and campaigns for the pseudo-url. The client agent identifies the set of keywords and campaigns as corresponding to the pseudo-url and now visible content. The client agent applies the keywords and corresponding campaigns.

Referring now to FIG. 7C, an embodiment of steps of a method of invisible content detection and contextualization is depicted. In brief overview, at step 750, the client agent detects visibility/invisibility status of pages being loaded and/or displayed on the browser. At step 755, the client agent generates handlers for invisible pages that may become visible. At step 760, the client agent detects via the event handler an invisible content/page becomes visible and generates a pseudo-url. At step 765, the client agent modifies the page data and sends the modified page data for the pseudo-url to the server. At step 770, the server process the page data for the pseudo-url. At step 592′, the server sends to the client agent for the pseudo-url matching keywords and corresponding campaigns. At step 594′, the agent hooks the keywords for the visible content corresponding to the pseudo-url. At step 596′, the agent detects mouse over/click of keywords and displays content in overlay for corresponding campaign (generally referred to as augmented content).

In further details of step 750, the client agent may detect the visibility and/or invisibility status of content or dynamically switched pages of pages 517A-517N. While a browser is display a web page comprising dynamic page content, such as dynamic page content that programmatically switches pages/page content via user selection of a page selector, the client agent may detect the visibility status of areas that may be displayed via the dynamic page contents. The visibility status may identify whether the area is visible or not visible. The client agent may detect visible versus invisible content as the page is being loaded and/or displayed on the client, such as via a browser. The agent may generate, obtain, use or access a model of the web page, such as a DOM model, which provides nodes and elements in a hierarchy or model for the web page. The model may be a programmatic model of the content of the web page that the agent can programmatically access, use and/or manipulate.

The agent via visibility detector may compare and match nodes or elements of the pages being loaded against a list of predetermined nodes or elements that may have invisible or hidden content. The agent may compare nodes of the web page or nodes corresponding to the dynamic page content to a predetermined list of nodes. Upon matching the nodes of the web page, such as in a DOM model of the page, the visibility detector may check whether the node is visible or not. The visibility detector may check a value of a property of the node, such as a CSS visibility property, to determine if the content for the node is visible or not.

Upon loading the page, the client agent may content harvest any content, invisible and/or visible and send page data to the server, such as described in any embodiments of steps 630, 635 of FIG. 6B, steps 650 and 655 of FIG. 6C or step 580 of FIG. 5K. In some embodiments, the client agent harvests content from the web page and area of the dynamic page content identified as visible. In some embodiments, the client agent harvests content from the web page and area of the dynamic page content identified as either visible or invisible. In some embodiments, the client agent sends page data 615 identifying nodes or content being invisible. In some embodiments, the client agent sends page data 615 identifying nodes or content being visible.

At step 755, the client agent may generate or provide event handlers for any nodes identified or detected as invisible. While the browser is displaying the web page, the agent may include for each of the areas of the dynamic page content detected to be invisible, an event handler in the dynamic page content. The event handler is designed and constructed to trigger upon an area becoming visible. The agent may attach the event handler to nodes corresponding to areas detected as invisible. The agent may attach event handler(s) to any nodes of the dynamic page content corresponding to areas that may switch between being visible and invisible. The agent may manipulate the model, such as the DOM model of the page and/or dynamic page content, to attach or include event handler(s). The client agent may modify the web page to include the handler. The client agent may change the DOM model or browser to include or recognize the handle. The client agent may provide handlers attached to invisible nodes to detect when the property changes for the node, such as the visibility/invisibility property. The handler may be fired or triggered upon a property change. The agent may receive the event triggered by the handler to perform the operations described herein, such as step 760.

At step 760, the client agent, such as via the handler, detects that a node or content for the node becomes visible or changes from invisible to visible. The handler may check the type of property that triggered the handler. The handler may check if the property corresponds to a visibility status. The handler may check if the property value indicates that the corresponding node or element is visible. Responsive to detecting the change to visibility, the handler triggers or causes the client agent to re-examine and/or modify the previously harvested content and to generate a pseudo-url for the now visible content. The agent, via pseudo-URL generator may generate a URL in accordance with any embodiments of the pseudo-URL generator described herein. The agent, via pseudo-URL generator may generate a URL comprising a URL unique to the visible area. The pseudo-URL generator may generate a URL based on an identifier of a node corresponding to the visible area. The pseudo-url generator generates a pseudo-url to uniquely identified the now visible content or node (sometimes generally referred to as the visible page).

At step 765, the client agent sends page data 615 identifying the pseudo-url or the URL generated by the pseudo-URL generator. In some embodiments, the client agent sends page data only for the visible page. In some embodiments, the client agent sends page data for the web page which includes the page data for the visible page. The page data may include or correspond to re-examined and/or modified content. The client agent may re-harvest the content of the visible page. For example, the content harvester may be executed to harvest content from the visible page. The client agent may identify content previously harvested for the visible page. The client agent may include the previously harvested content of the visible page in the page data. The client agent may modify the previously established or harvested page data to identify the previously invisible node or content as visible. The client agent may modify the previously established or harvested page data to identify the previously visible node or content as invisible. In some embodiments, the client agent removes page data for invisible pages or pages now invisible.

At step 770, the server receives the page data. The server receives page data for or identified by the pseudo-url. The server may process the page data for the now visible page. The server may process the harvested content for the now visible page. The server may process the page data for the web page. The server may process the page data for the web page including page data for the visible page(s). The server may determine keywords for the page data and determine campaigns to apply for the keywords. The server may determine keywords for the page data of the visible page and determine campaigns to apply for the keywords. The server may determine keywords for the content of the visible page and determine campaigns to apply for the keywords. The server may determine keywords for a combination of the page data of the web page and the now visible page and determine campaigns to apply for the keywords. The server may determine keywords for a combination of the content of the web page and the now visible page and determine campaigns to apply for the keywords.

Step 770 may comprise any embodiments of server processing described in connections with steps 635 and 640 described in connection with FIG. 6B and steps 660 and 665 described in connection with FIG. 6C. Step 770 may comprise any of the steps 582, 584, 586, 588 and 590 and embodiments thereof described in connection with FIG. 5K. The server may determine keywords for the visible page based on harvested content from the visible page and/or one or more invisible pages.

At step 592′, 594′ and 596′, the method may include any embodiments of these steps described in connection with FIG. 5K. At step 592′, the server sends to the client agent keywords and campaigns for the pseudo-url. At step 592′, the server may communicate campaigns selected by the server based on the identified keywords from the page data including unhookable text. In some embodiments, at step 592′, the server may communicate campaigns selected by the server based on the formatting of keywords from the page data. In some embodiments, at step 592′, the server may communicate campaigns selected by the server based on the identification information of keywords from the page data. At step 594′ the client agent receives the keywords and campaigns for the pseudo-url and matches/uses this information for the now visible page/content. At step 594′, the client agent hooks the identified keywords on the visible page/content of the currently displayed web page. At step 596′, the augmented content is displayed as an overlay or tooltip on the visible page/content responsive to detecting a mouse-over.

In view of the systems and methods described herein, embodiments of the present solution dynamically delivers augmented content and advertisement content targeted to or related to contents of pages as they are programmatically switched by a user via dynamic page content on the web page. In some embodiments, at the point in time of a page being switched to visible in the dynamic page content, the present solution provides targeted augmented content and advertisement related to the now visible content area or the newly displayed content of the dynamic page content to the user.

What is claimed:

1. A method for detecting changes to content of dynamic page content of a web page, the method comprising
(a) detecting, by an agent, executing on a client, while a browser is displaying a web page comprising dynamic page content that programmatically switches page content responsive to a user selection via a page selector, whether each of the areas that may be displayed within the dynamic page content is visible or not visible;
(b) including, by the agent, while the browser is displaying the web page, for each of the areas of the dynamic page content detected to be invisible, an event handler in the dynamic page content to be triggered upon each area becoming visible;
(c) generating, by the agent responsive to triggering of the event handler for an area, a uniform resource locator (URL) for the area switched to be visible in the dynamic page content; and
(d) transmitting, by the agent to a server, page data identified by the URL, the page data comprising text identified from the page content of the visible area of the dynamic page content.

2. The method of claim 1, further comprising determining, by the server, keywords from the text of the page data for the visible area.

3. The method of claim 2, further comprising determining, by the server, a campaign for the keywords.

4. The method of claim 3, further communicating, by the server to the client, the campaign for the URL.

5. The method of claim 1, wherein step (a) further comprises comparing, by the agent, nodes of the web page to a predetermined list of nodes.

6. The method of claim 5, further comprising checking, by the agent, a visibility property corresponding to a node matching the predetermined list of nodes.

7. The method of claim 1, wherein step (b) further comprises attaching, by the agent, the event handler to nodes corresponding to areas detected as invisible.

8. The method of claim 1, wherein step (c) further comprises generating, by the agent, a URL comprising a URL unique to the visible area.

9. The method of claim 1, wherein step (c) further comprises generating, by the agent, a URL based on an identifier of a node corresponding to the visible area.

10. The method of claim 1, wherein step (d) further comprises harvesting, by the agent, content from the visible area to generate the page data.

11. A system for detecting changes to content of dynamic page content of a web page, the system comprising
an agent, executing on a client comprising a browser displaying a web page comprising dynamic page content that programmatically switches page content responsive to a user selection via a page selector
a visibility detector of the agent detects, while the browser is displaying the web page, whether each of the areas that may be displayed within the dynamic page content is visible or not visible;
an event handler included by the agent in the dynamic page content for each of the areas of the dynamic page content detected to be invisible, the event handler to be triggered upon each area becoming visible;
a pseudo-URL generator of the agent, responsive to triggering of the event handler for an area, generates a uniform resource locator (URL) for the area switched to be visible in the dynamic page content; and
wherein the agent transmits to a server page data identified by the URL, the page data comprising text identified from the page content of the visible area of the dynamic page content.

12. The system of claim 11, wherein the server determines keywords from the text of the page data for the visible area.

13. The system of claim 12, wherein the server determines a campaign for the keywords.

14. The system of claim 13, wherein the server communicates to the client the campaign for the URL.

15. The system of claim 11, wherein the visibility detector compares nodes of the web page to a predetermined list of nodes.

16. The system of claim 15, wherein the visibility detector checks a visibility property corresponding to a node matching the predetermined list of nodes.

17. The system of claim 11, wherein the agent attaches the event handler to nodes corresponding to areas detected as invisible.

18. The system of claim 11, wherein the pseudo-URL generator generates a URL comprising a URL unique to the visible area.

19. The system of claim 11, wherein the pseudo-URL generator generates a URL based on an identifier of a node corresponding to the visible area.

20. The system of claim 11, wherein the agent harvests content from the visible area to generate the page data.
